(19) United States
(12) Patent Application Publication
(10) Pub. No.: US 2023/0359907 A1
(43) Pub. Date: Nov. 9, 2023

(54) SYSTEM(S) AND METHOD(S) FOR JOINTLY LEARNING MACHINE LEARNING MODEL(S) BASED ON SERVER DATA AND CLIENT DATA

(71) Applicant: GOOGLE LLC, Mountain View, CA (US)

(72) Inventors: Sean Augenstein, San Mateo, CA (US); Andrew Hard, Menlo Park, CA (US); Kurt Partridge, San Francisco, CA (US); Rajiv Mathews, Sunnyvale, CA (US); Lin Ning, San Jose, CA (US); Karan Singhal, Roslyn, NY (US)

(21) Appl. No.: 17/848,947

(22) Filed: Jul. 1, 2022

Related U.S. Application Data
(60) Provisional application No. 63/339,812, filed on May 9, 2022.

(51) Int. Cl. G06N 5/02

(52) U.S. Cl. CPC G06N 5/022

(57) ABSTRACT

Implementations disclosed herein are directed to various techniques for mitigating and/or preventing catastrophic forgetting in federated learning of global machine learning (ML) models. Implementations may identify a global ML model that is initially trained at a remote server based on a server data set, determine server-based data for global weight(s) of the global ML model, and transmit the global ML model and the server-based data to a plurality of client devices. The server-based data may include, for example, EWC loss term(s), client augmenting gradients, server augmenting gradients, and/or server-based data. Further, the plurality client devices may generate, based on processing corresponding predicted output and using the global ML model, and based on the server-based data, a corresponding client gradient, and transmit the corresponding client gradient to the remote server. Implementations may further generate an updated global ML model based on at least the corresponding client gradients.

### BACKGROUND

Federated learning of machine learning (ML) model(s) is an increasingly popular ML technique for training of ML model(s). In traditional federated learning, a local ML model is stored locally on a client device of a user, and a global ML model, that is a cloud-based counterpart of the local ML model, is stored remotely at a remote system (e.g., a cluster of servers). The client device, using the local ML model, can process user input detected at the client device to generate predicted output, and can compare the predicted output to ground truth output to generate a gradient using supervised learning techniques. Further, the client device can transmit the gradient to the remote system. The remote system can utilize the gradient, and optionally additional gradients generated in a similar manner at additional client devices, to update weights of the global ML model. Further, the remote system can transmit the global ML model, or updated weights of the global ML model, to the client device. The client device can then replace the local ML model with the global ML model, or replace the weights of the local ML model with the updated weights of the global ML model, thereby updating the local ML model.

Notably, the global ML model may be initially trained using a server data set at the remote system, and fine-tuned using the federated learning framework in the manner described above. Put another way, the global ML model may be initially trained at the remote server and based on the server data set until it is usable, and may be subsequently fine-tuned in a privacy-sensitive manner and based on the client data that is more likely to be encountered when the global ML model is deployed at inference. However, ML models trained in this may be prone to catastrophic forgetting in that information learned from the server data set in the initial training may be abruptly forgotten when updating the weights of the global ML model based on gradients generated at client devices when using this naïve fine-tuning.

### SUMMARY

Implementations disclosed herein are directed to implementing various techniques in federated learning of machine learning (ML) model(s) to mitigate catastrophic forgetting of the ML model(s). Implementations can identify a given global ML model that was initially trained (e.g., bootstrapped) at a remote server based on a server data set, and determine server-based data to be utilized in generating corresponding client gradients that are generated based on corresponding client data and that are utilized to fine-tune the given global ML model. Further, implementations can transmit (i) the given global ML model and (ii) the server-based data to at least a given client device to cause the given client device to generate, based on processing the corresponding client data using (i) the given global ML model and based on (ii) the server-based data, a corresponding client gradient, and to transmit the corresponding client gradient back to the remote server. Moreover, implementations can generate a given updated global ML model based on the corresponding client gradient received from the given client device (and optionally additional corresponding client gradients received from additional client devices).

For example, assume the given global ML model corresponds to a global automatic speech recognition (ASR) model that is initially trained at the remote server based on a corpus of audio data that is available to the remote server. In this example, the server-based data may be determined based on global weight(s) of the global ASR model and the corpus of audio data utilized to initially train the global ASR model. Further assume that the global ASR model and the server-based data is transmitted to a given client device for fine-tuning of the global ASR model based on client data that is generated locally at the given client device. In this example, the given client device can obtain audio data that captures one or more spoken utterances of a user of the client, and can process the audio data, using the global ASR model (e.g., an instance of the global ASR model that is stored locally at the given client device in response to receiving the global ASR model from the remote server), to generate predicted output (e.g., recognized text, predicted phoneme(s), etc.). Further, the given client device can generate a corresponding client gradient based on the predicted output using various supervised or semi-supervised learning techniques. For instance, the given client device can modify or augment the corresponding client gradient based on the server-based data, and transmit the modified or augmented corresponding client gradient back to the remote server. Moreover, the remote server can update the global weight(s) of the global ASR model based on the corresponding client gradient (and optionally other corresponding client gradients received from other client devices participating in the federated learning in the global ASR model), thereby generating the updated global ASR model.

In some implementations, the server-based data may include one or more corresponding elastic weight consolidation (EWC) loss terms for one or more corresponding global weights of the given global ML model. The one or more corresponding EWC loss terms may add a corresponding loss penalty that slows down learning of the one or more corresponding global weights of the given global ML model during the fine-tuning of the given global ML model based on the client data. Put another way, the one or more corresponding EWC loss terms ensure that the one or more corresponding global weights of the given global ML model are not overfit when the given global ML model is subsequently updated based on the client data (e.g., via the corresponding client gradient), thereby mitigating and/or eliminating catastrophic forgetting.

In these implementations, the one or more corresponding EWC loss terms may be determined based on, for example, a corresponding Fisher information matrix that is determined based on the one or more corresponding global weights of the given global ML model and for the server data set that is utilized to initially train the given global ML model at the remote server. The Fisher information seeks to measure the amount of information that an observable random variable carries about an unknown parameter of a distribution, and the Fisher information matrix may be computed as an expectation value of this measure represented in matrix form (e.g., a Hessian matrix). In implementations where the given global ML model is initially trained based on multiple server data sets, each of the multiple server data sets may be associated with a set of one or more corresponding EWC loss terms that are determined based on corresponding Fisher information matrices for each of the multiple server data sets.

In some versions of these implementations, the one or more corresponding EWC loss terms may be determined based on a diagonal of the Fisher information matrix. For example, corresponding values of the diagonal of the Fisher information matrix may be utilized as the one or more corresponding EWC loss terms for the one or more corresponding global weights. For instance, a first value of the diagonal of the Fisher information matrix (e.g., row 1, column 1) may be utilized as a first EWC loss term for a first global weight, a second value of the diagonal of the Fisher information matrix (e.g., row 2, column 2) may be utilized as a second EWC loss term for a second global weight, a third value of the diagonal of the Fisher information matrix (e.g., row 3, column 3) may be utilized as a third EWC loss term for a third global weight, and so on for each of the other global weights of the global ML model. In additional or alternative versions of these implementations, additional or alternative values or combinations of values may be utilized in determining the one or more EWC loss terms, such that a given EWC loss term may be utilized in updating multiple global weights of the one or more global weights and/or multiple EWC loss terms may be utilized in updating a given global weight of the one or more global weights, but that these implementations may not be as computationally efficient.

Continuing with the above example where the given global ML model corresponds to the global ASR model, the corresponding client gradient that is generated locally at the given client device and that is transmitted back to the server may be modified or augmented using the one or more corresponding EWC loss terms. For instance, the corresponding client gradient that is generated locally at the given client device can be combined with the one or more corresponding EWC loss terms in a weighted or non-weighted manner prior to being transmitted back to the remote server. Accordingly, when the remote server subsequently updates the global ASR model based on the corresponding client gradient, the one or more updated weights of the updated global ASR model are not overfit to the client data.

In some versions of these implementations, and at a subsequent iteration of training the given global ML model, implementations can determine an updated Fisher information matrix and one or more corresponding updated EWC loss terms (e.g., updated server-based data) based on the server data set and based on the one or more corresponding updated global weights of the given updated global ML model. Further, implementations can transmit (iii) the given update global ML model and (iv) the updated server-based data to at least the given client device to cause the given client device to generate, based on processing the corresponding additional client data using (iii) the given updated global ML model and based on (iv) the updated server-based data, a corresponding additional client gradient, and to transmit the corresponding additional client gradient back to the remote server. Moreover, implementations can generate a given further updated global ML model based on the corresponding additional client gradient received from the given client device (and optionally further additional corresponding client gradients received from additional client devices). The given global ML model may continue being fine-tuned in this manner until one or more conditions are satisfied for causing the given global ML model to be deployed for inference at the given client device and/or a plurality of additional client devices.

In some implementations, the server-based data may include a client augmenting gradient for a server data set that is utilized in training the given global ML model, and according to a one-way gradient transfer technique. The client augmenting gradient may be subsequently utilized by the plurality of client devices to ensure that corresponding client gradients generated during an iteration of federated learning are augmented in a manner that mitigates and/or eliminates catastrophic forgetting of the given global ML model. For instance, the remote server may sample a batch of server data from the server data set that was utilized to initially train the given global ML model, and may determine the client augmenting gradient with respect to the batch of server data and based on the one or more global weights of the given global ML model as a stochastic gradient of a loss function for the given global ML model.

Continuing with the above example where the given global ML model corresponds to the global ASR model, the corresponding client gradient that is generated locally at the given client device can be augmented using the client augmenting gradient. For instance, the corresponding client gradient that is generated locally at the given client device can be combined with the client augmenting gradient in a weighted or non-weighted manner prior to being transmitted back to the remote server. Accordingly, when the remote server subsequently updates the global ASR model based on the corresponding client gradient, the one or more updated weights of the updated global ASR model are not overfit to the client data. In this example, the remote server may determine an updated client augmenting gradient for a subsequent iteration of federated learning of the global ASR model based on an additional batch of the server data and the one or more updated weights of the global ASR model.

In some versions of those implementations, the server-based data may include a server augmenting gradient for a client data set that is utilized in training the given global ML model, and according to a two-way gradient transfer technique. However, in these implementations, the client augmenting gradient may be transmitted to the plurality of client devices without transmitting the server augmenting gradient to the plurality of client devices. Rather, in these implementations, the server augmenting gradient may be subsequently utilized to augment server gradients that are generated at the remote server using the given ML model to enable the given ML model to be trained on mixed data sets (e.g., the client data set utilized in generating the corresponding client gradient and a remote data set utilized in generating the server gradients) during a given iteration of federated learning of the given ML model. For instance, the remote server may utilize one or more corresponding client gradients from a prior iteration of federated learning of the given global ML model as the server augmenting gradient, or may receive developer input from a developer via a developer client device that initializes the server augmenting gradient.

Continuing with the above example where the given global ML model corresponds to the global ASR model, the corresponding client gradients may be generated in the same or similar manner described above with respect to the one-way gradient transfer technique. However, in the two-way gradient transfer technique, the remote server may obtain audio data that is available to the remote server as the server data, process the audio data, using the global ASR model to generate predicted output, and generate the server gradient using various supervised, semi-supervised, or unsupervised learning techniques. Further, the server gradient that is generated at the remote server can be combined with the server augmenting gradient in a weighted or non-weighted manner prior to being utilized in updating the global ASR model. Accordingly, when the remote server subsequently updates the global ASR model based on the corresponding server gradient, the one or more updated weights of the updated global ASR model are not overfit to the client data or the server data. In this example, the remote server may determine an updated server augmenting gradient for a subsequent iteration of federated learning of the global ASR model based on processing of the client data during the same iteration of federated learning of the global ASR model.

By using the techniques described herein, various technical advantages can be achieved. As one non-limiting example, in utilizing the one or more corresponding EWC loss terms, the one-way gradient transfer technique, and/or the two-way gradient transfer technique as described herein, catastrophic forgetting of ML models can be mitigated and/or eliminated by limiting how much a given corresponding client gradient and/or a given server gradient effects the weights of the ML models when the ML model is updated based on the given corresponding client gradient and/or the given server gradient. As a result, the ML models may be more robust in terms of precision and/or recall. As another non-limiting example, the server-based data may be determined, for a given iteration of federated learning, at the remote server and while maintaining security of client data, thereby obviating the need for the client devices to consume unnecessary computational and/or network resources in determining the server-based data that is utilized locally at the client devices to mitigate and/or prevent catastrophic forgetting. For instance, the client devices need not process a large quantity of data that was utilized to initially train the given global ML model. Rather, each of the client devices that participate in the fine-tuning of the given global ML model can leverage the server-based data that is determined at the server. Also, for instance, the remote server need not process any client data directly, thereby preserving the data privacy and data security benefits of federated learning.

The above description is provided as an overview of some implementations of the present disclosure. Further description of those implementations, and other implementations, are described in more detail below.

### BRIEF DESCRIPTION OF THE DRAWINGS

FIG. 1 depicts an example process flow that demonstrates various aspects of the present disclosure, in accordance with various implementations.

FIG. 2 depicts a block diagram that demonstrates various aspects of the present disclosure, and in which implementations disclosed herein may be implemented.

FIG. 3 depicts a flowchart illustrating an example method of server-side aspects for utilizing server-based data in updating a global machine learning (ML) model, in accordance with various implementations.

FIG. 4 depicts a flowchart illustrating an example method of server-side aspects for utilizing a client augmenting gradient for a one-way gradient transfer technique in updating a global machine learning (ML) model, in accordance with various implementations.

FIG. 5 depicts a flowchart illustrating an example method of server-side aspects for utilizing a client augmenting gradient and a server augmenting gradient for a two-way gradient transfer technique in updating a global machine learning (ML) model, in accordance with various implementations.

FIG. 6 depicts a flowchart illustrating an example method of server-side aspects for utilizing elastic weight consolidation (EWC) loss terms in updating a global machine learning (ML) model, in accordance with various implementations.

FIG. 7 depicts a flowchart illustrating an example method of client-side aspects for utilizing elastic weight consolidation (EWC) loss terms in updating a global machine learning (ML) model, in accordance with various implementations.

FIG. 8 depicts an example architecture of a computing device, in accordance with various implementations.

### DETAILED DESCRIPTION

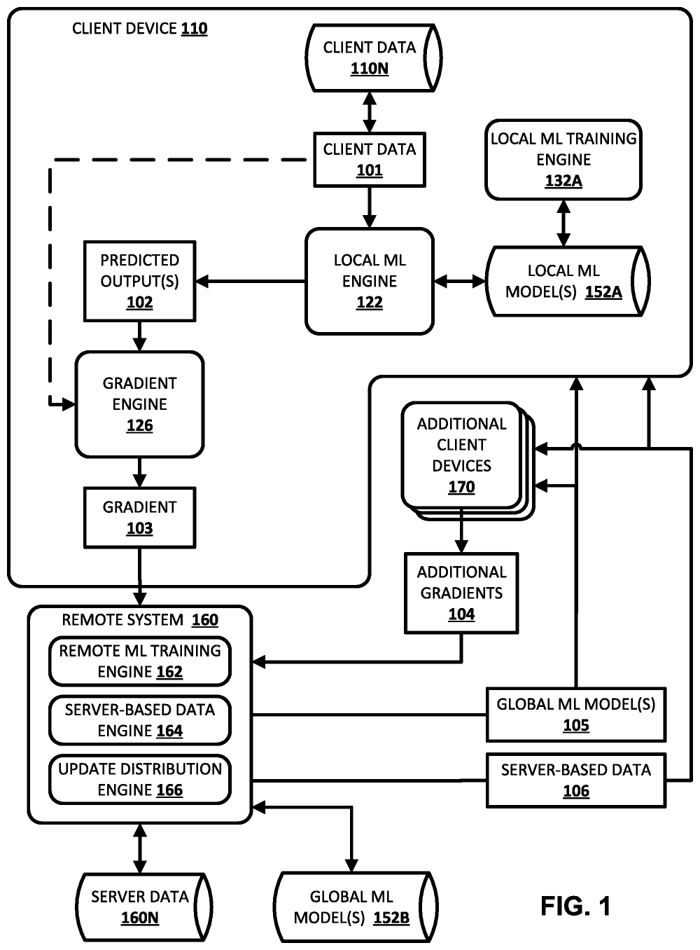

FIG. 1 depicts an example process flow that demonstrates various aspects of the present disclosure. A client device 110 is illustrated in FIG. 1, and includes the components that are encompassed within the box of FIG. 1 that represents the client device 110. Local ML engine 122 can process client data 101, using local machine learning (ML) model(s), to generate predicted output(s) 102. The client data 101 can be, for example, audio data that captures a spoken utterance and/or other noise that is generated by one or more microphones of the client device 110, vision data that captures an environment of the client device 110 (e.g., a user of the client device 110, including hand gesture(s) and/or movement(s), body gesture(s) and/or body movement(s), eye gaze, facial movement, mouth movement, etc.) that is generated via one or more vision components of the client device 110, textual data generated via one or more interfaces of the client device (e.g., a touchscreen, a keyboard, etc.), and/or other client data. In some implementations, the client data 101 may be obtained as it is generated by one or more respective sensor components. In additional or alternative implementations, the client data 101 may be previously generated and obtained from on-device storage of the client device 110 (e.g., from client data database 110N).

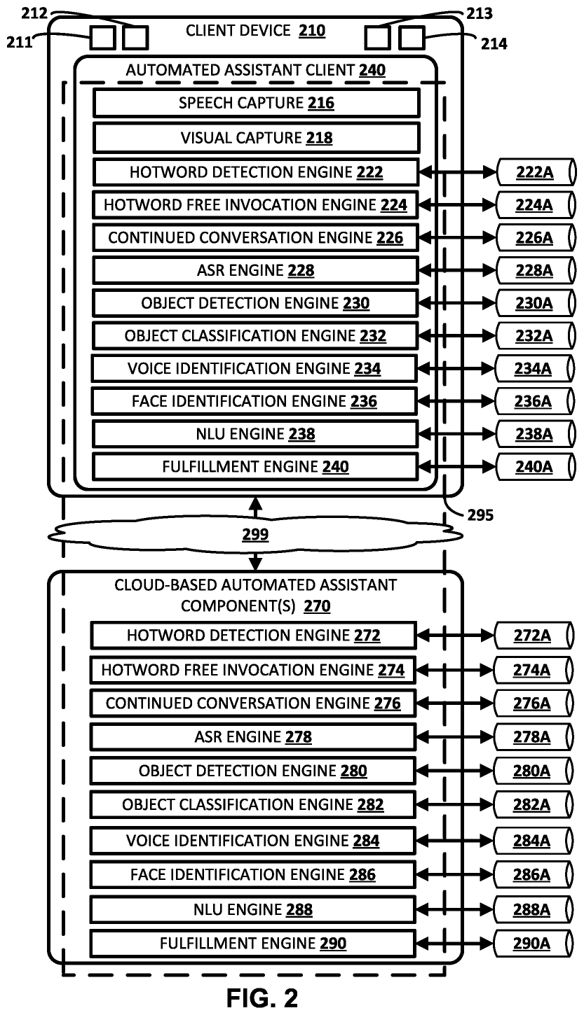

The local ML model(s) can include, for example, one or more local ML models that are stored in on-device memory of the client device (e.g., local ML model(s) database 152A), and that are local counterparts of corresponding global ML model(s) 105 received from a remote system 160 (e.g., a high-performance remote server or cluster of high-performance remote servers). Notably, the global ML model(s) 105 may be initially trained by the remote system 160 (e.g., via remote ML training engine 162) and based on a server data set (e.g., from server data database 160N), and transmitted to the client device 110 and one or more of the additional client devices 170. These client devices 110, 170 may store the global ML model(s) 105 in corresponding on-device storage as the local ML models to fine-tune the global ML models based on a client data set and in a federated manner as described herein. These ML models can include, for example, various audio-based ML models that are utilized to process audio data generated locally at the client devices 110, 170, various vision-based ML models that are utilized to process vision data generated locally at the client devices 110, 170, and/or any other ML model that may be trained in the federated manner as described herein (e.g., the various ML models described with respect to FIG. 2).

For example, assume that a global ML model corresponding to a global hotword detection model is received at the client device 110 and from the remote system 160. In this example, the client device 110 may store the global hotword detection model in the local ML model(s) database 152A as a local hotword detection model that is a local counterpart (e.g., local to the client device 110) of the global hotword detection model. In storing the global hotword detection model in the local ML model(s) database 152A as the local hotword detection model, the client device 110 may optionally replace a prior instance of the local hotword model (or one or more local weights thereof) with the global hotword detection model (or one or more global weights thereof). Further, the client device 110 can process audio data (e.g., as the client data 101), using the local hotword detection model, to generate a prediction of whether the audio data captures a particular word or phrase (e.g., “Assistant”, “Hey Assistant”, etc.) that, when detected, causes an automated assistant executing at least in part at the client device to be invoked as the predicted output(s) 102. The prediction of whether the audio data captures the particular word or phrase can include a binary value of whether the audio data is predicted to include the particular word or phrase, a probability or log likelihood that of whether the audio data is predicted to include the particular word or phrase, and/or other value(s) and/or measure(s).

As another example, assume that a global ML model corresponding to a global hotword free invocation model is received at the client device 110 and from the remote system 160. In this example, the client device 110 may store the global hotword free invocation model in the local ML model(s) database 152A as a local hotword detection model that is a local counterpart (e.g., local to the client device 110) of the global hotword detection model in the same or similar manner described with respect to the above example. Further, the client device 110 can process vision data (e.g., as the client data 101), using the local hotword free invocation model, to generate a prediction of whether the vision data captures a particular physical gesture or movement (e.g., lip movement, eye gaze, etc.) that, when detected, causes the automated assistant executing at least in part at the client device to be invoked as the predicted output(s) 102. The prediction of whether the vision data captures the particular physical gesture or movement can include a binary value of whether the vision data is predicted to include the particular physical gesture or movement, a probability or log likelihood that of whether the vision data is predicted to include the particular physical gesture or movement, and/or other value(s) and/or measure(s).

In some implementations, gradient engine 126 can process at least the predicted output(s) 102 to generate a gradient 103. In some versions of those implementations, the gradient engine 126 can generate the gradient 103 using one or more supervised learning techniques (e.g., as indicated by the dashed line from the client data 101 to the gradient engine 126). For example, again assume that the global ML model corresponding to the global hotword detection model is received at the client device 110. Further assume that the client data 101 corresponds to audio data previously generated by microphone(s) of the client device 110 (e.g., where the client data is obtained from the client data database 110N). In this example, the client device 110 may also have stored an indication of whether the audio data does, in fact, include a particular word or phrase that invoked the automated assistant, and the gradient engine 126 may utilize the stored indication as a supervision signal that may be utilized in generating the gradient 103.

For instance, assume that a user engaged in a dialog session with the automated assistant subsequent to providing a spoken utterance that is captured in the audio data. In this instance, the user engaging in the dialog session with the automated assistant may cause the client device 110 to generate and store an indication that the audio data does, in fact, include the particular word or phrase. Accordingly, the gradient engine 126 can compare the predicted output(s) 102 (e.g., the predicted value of whether the audio data captures the particular word or phrase) to the stored indication to generate the gradient 103 to reinforce that the audio data does include the particular word or phrase. In contrast, assume that the user did not engage in the dialog session with the automated assistant subsequent to providing the spoken utterance that is captured in the audio data. In this instance, the user not engaging in the dialog session with the automated assistant may cause the client device 110 to generate and store an indication that the audio data does not, in fact, include the particular word or phrase. Accordingly, the gradient engine 126 can compare the predicted output(s) 102 (e.g., the predicted value of whether the audio data captures the particular word or phrase) to the stored indication to generate the gradient 103 to reinforce that the audio data does not include the particular word or phrase. In these instances, the gradient 103 may be a zero gradient (e.g., when the predicted output(s) 102 match the supervision signal) or non-zero gradient (e.g., based on extent of mismatching between the predicted output(s) 102 and the supervision signal and made based on a deterministic comparison therebetween).

In additional or alternative implementations, the gradient engine 126 can generate the gradient 103 using one or more unsupervised or semi-supervised learning techniques. For example, again assume that the global ML model corresponding to the global hotword detection model is received at the client device 110. Further assume that the client data 101 corresponds to audio data previously generated by microphone(s) of the client device 110 (e.g., where the client data is obtained from the client data database 110N). In this example, the client device 110 may not have access to any stored indication of whether the audio data does, in fact, include a particular word or phrase that invoked the automated assistant. Accordingly, the gradient engine 126 may not have access to an explicit supervision signal for generating the gradient 103. Nonetheless, the gradient engine 126 may utilize various unsupervised or semi-supervised learning techniques to generate the gradient 103 even without the explicit supervision signal. These unsupervised or semi-supervised learning techniques can include, for example, a teacher-student technique, a knowledge distillation technique, and/or other unsupervised or semi-supervised learning techniques.

For instance, the client device 110 may process, using a benchmark hotword model (e.g., stored in the local ML model(s) database 152A), the audio data to generate benchmark output(s) indicative of whether the audio data captures a particular word or phrase (e.g., “Assistant”, “Hey Assistant”, etc.) that, when detected, causes an automated assistant executing at least in part at the client device to be invoked. In these and other instances, the benchmark hotword model may be the local hotword detection model utilized to generate the predicted output(s) 102 and/or another, distinct hotword detection model stored locally at the client device 110 (e.g., an existing hotword model that is deployed for inference at the client device 110). Further, the gradient engine 126 may compare the predicted output(s) and the benchmark output(s) to generate the gradient 103 in this semi-supervised teacher-student technique. Although the above example of semi-supervised learning, it should be understood that is provided as one non-limiting example of semi-supervised learning and is not meant to be limiting. Moreover, although the above examples are described with respect to hotword detection models, it should be understood that is also for the sake of example and is not meant to be limiting.

In various implementations, and in addition generating the gradient 103 based on at least the predicted output(s) 102, the gradient engine 126 may generate the gradient 103 based on server-based data 106. The server-based data 106 may be generated via server-based data engine 164. Further, the server-based data 106 may be utilized by the gradient engine 126 to augment or otherwise modify the gradient 103 generated based on the predicted output(s) 102. By further augmenting or otherwise modifying the gradient 103 based on the server-based data 106, the gradient engine 126 can ensure that subsequent updating of the global ML model(s) 105 does not result in catastrophic forgetting.

In some versions of those implementations, the server-based data 106 may include one or more corresponding elastic weight consolidation (EWC) loss terms for one or more corresponding global weights of the global ML model(s) 105. The one or more corresponding EWC loss terms may add a corresponding loss penalty that slows down learning of the one or more corresponding global weights of the global ML model(s) 105 during the fine-tuning of the global ML model(s) 105 based on a client data set (e.g., based on the client data 101). Put another way, the one or more corresponding EWC loss terms ensure that the one or more corresponding global weights of the global ML model(s) 105 are not overfit when the global ML model(s) 105 is subsequently updated based on the client data set, thereby mitigating and/or eliminating catastrophic forgetting.

In these implementations, the server-based data engine 164 may determine the one or more corresponding EWC loss terms based on, for example, a corresponding Fisher information matrix that is determined based on the one or more corresponding global weights and for a corresponding server data set that is utilized to initially train the global ML model(s) 105. In this example, the Fisher information seeks to measure the amount of information that an observable random variable carries about an unknown parameter of a distribution, and the Fisher information matrix may be computed as an expectation value of this measure as indicated below by Equation 1:

$$F ( w ) = E [ {( \frac{\partial }{\partial w} L ( X ; w ) )}^{2} \vert w ] \qquad ( Equation 1 )$$

where the Fisher information is defined as the variance of the partial derivative with respect to the parameters w of the loss, and where

$$g ( X ; w ) = \frac{\partial }{\partial w} L ( X ; w )$$

is a gradient derived from the loss function L(X; w). Put another way, the Fisher information may be computed as an expectation value of the square of the gradient. Further, the Fisher information may be represented in matrix form (e.g., a Hessian matrix).

In some implementations, the server-based data engine 164 may determine the one or more corresponding EWC loss terms based on a diagonal of the Fisher information matrix. In some versions of these implementations, the system may utilize each corresponding value of the diagonal of the Fisher information matrix as a corresponding EWC loss term for a corresponding one of the one or more corresponding global weights. In additional or alternative versions of these implementations, additional or alternative values or combinations of values may be utilized in determining the one or more corresponding EWC loss terms, such that a given EWC loss term may be utilized in updating multiple global weights of the one or more global weights and/or multiple EWC loss terms may be utilized in updating a given global weight of the one or more global weights, but that these implementations may not be as computationally efficient.

In these implementations, the gradient engine 126 may generate the gradient 103 as a function of at least the predicted output(s) 102 and the server-based data 106. For example, the gradient engine 126 may generate the gradient 103 using supervised, semi-supervised, or unsupervised learning techniques as described above. However, in these implementations, the gradient engine 126 may augment the gradient 103 using the one or more corresponding EWC loss terms as indicated below by Equation 2:

$$L ( w ) = {L}_{B} ( w ) + \frac{1}{2} λ {Σ}_{i} {{F}_{i} ( {w}_{i} - {w}_{A , i} )}^{2} \qquad ( Equation 2 )$$

where w_{A} corresponds to one or more corresponding current weights for the global ML model(s) 105, where F corresponds to the Fisher information, where i is an index over the parameters w of the loss, where L_{B}(w) corresponds to the gradient determined based on at least the predicted output(s) 102, and where λ is a tunable parameter that sets the strength of regularization. Put another way, the gradient engine 126 may determine the gradient 103 as a sum of the gradient determined based on at least the predicted output(s) and the one or more corresponding EWC loss terms. Although Equation 2 described the gradient 103 as a sum, it should be understood that is for the sake of example and other weighted or non-weighted combinations of this data may be utilized in generating the gradient 103.

Although the above implementations are described with respect to the server-based data 106 being EWC loss terms, it should be understood that this is only one technique for mitigating catastrophic forgetting, and that other techniques exist.

For example, in additional or alternative implementations, the server-based data 106 may include a client augmenting gradient that is utilized as part of a one-way gradient transfer technique for mitigating and/or eliminating catastrophic forgetting of the global ML model. The client augmenting gradient may be determined by the server-based data engine 164 and subsequently utilized by the client device 110 to ensure that the gradient 103 is augmented in a manner that mitigates and/or eliminates catastrophic forgetting of the global ML model. For instance, the gradient engine 126 may generate a gradient in the same or similar manner described above and using various supervised, semi-supervised, or unsupervised learning techniques, and augment this gradient with the client augmenting gradient to generate the gradient 103 that is transmitted back to the remote system 160, thereby minimizing the impact of the given client data utilized in generating the gradient based on at least the predicted output(s) 102.

In these implementations, the server-based data engine 164 may sample a batch of server data (e.g., from the server data database 160N) that was utilized in initially training the global ML model. Further, the server-based data engine 164 may determine the client augmenting gradient with respect to the batch of server data and based on the one or more global weights of the global ML model as a stochastic gradient of a loss function for the global ML model as indicated below by Equation 3:

g(x^{(t)};B^{(t)}) (Equation 3)

where x^{(t)} corresponds to the global ML model at a t iteration of federated learning of the global ML model, where B^{(t)} corresponds to the batch of server data sampled at the t iteration of federated learning of the global ML model, and where g(x^{(t)}; B^{(t)}) corresponds to the client augmenting gradient at the t iteration of federated learning. Accordingly, the gradient 103 that is transmitted back to the remote system may be a weighted or non-weighted combination of the gradient generated based on at least the predicted output(s) 102 and the client augmenting gradient.

In some versions of those additional or alternative implementations, the server-based data 106 may additionally include a server augmenting gradient that is utilized as part of a two-way gradient transfer technique for mitigating and/or eliminating catastrophic forgetting of the global ML model. Similar to the client augmenting gradient, the server augmenting gradient may be determined by the server-based data engine 164. However, the server augmenting gradient may not be transmitted to the client device 110. For instance, a remote gradient engine (not depicted) of the remote system 160 may generate a gradient (e.g., a server gradient) in the same or similar manner described above, but with respect to the global ML model and additional server data that is available to the remote system 160 and that is in addition to any server data utilized to initially train the global ML model, and using various supervised, semi-supervised, or unsupervised learning techniques. The remote system 160 may further use the server augmenting gradient to augment this server gradient to generate an augmented server gradient that may additionally, or alternatively, be utilized in updating the global ML model. Put another way, the global ML model may be updated based on both corresponding augmented client gradients generated in the manner described above with respect to the one-way gradient transfer technique and also based on corresponding segmented server gradients in the two-way gradient transfer technique, thereby minimizing the impact of both the given client data utilized in generating the gradient based on at least the predicted output(s) 102 and the server data utilized in generating the server gradient.

Notably, the remote system 160 may not be able to directly access client data to determine the server augmenting gradient due to privacy considerations. Accordingly, in some versions of these implementations, the remote system 160 may initialize the server augmenting gradient based on developer input received from a developer via a developer client device (not depicted in FIG. 1). In additional or alternative versions of these implementations, the remote system 160 may initialize the server augmenting gradient based on one or more client gradients from a prior iteration of federated learning of the global ML model.

In these implementations, the remote system 160 may further cause the client device 110 to determine a corresponding updated server augmenting gradient at each subsequent iteration of federated learning, and determine an updated server augmenting gradient based on the corresponding updated server augmenting gradient received from each of the plurality of client devices that participate in the federated learning of the global ML model. For instance, the server-based data engine 164 may determine updated server augmenting gradient as a weighted or non-weighted combination of the corresponding updated server augmenting gradients received from the plurality of client devices. The client device 110 may determine the corresponding updated server augmenting gradient with respect to the client data utilized in generating the gradient 103 and based on the one or more global weights of the global ML model as a stochastic gradient of a loss function for the global ML model as indicated below by Equation 4:

$${\tilde{g}}_{s}^{( t + 1 )} = - \frac{1}{{ηΣ}_{i} {k}_{i}} {Σ}_{i} {Δ}_{i}^{( t )} - {\tilde{g}}_{c}^{- ( t )} \qquad ( Equation 4 )$$

where η is a client learning rate, where Σᵢkᵢ is a quantity of iterations of federated that have been performed at the client device 110, where Δᵢ^{(t)} is a change to a local instance of the global ML model (e.g., the gradient 103 in implementations where the gradient is transmitted to the remote system 160 or updated weights in implementations where the gradient 103 is utilized to update the local instance of the global ML model locally at the client device 110), where \tilde{g}_{c}^{-(t)} is the client augmenting gradient for the t iteration of federated learning of the global ML model, and where \tilde{g}ₛ^{(t+1)} is the corresponding updated server augmenting gradient for a next t iteration of federated learning of the global ML model. Accordingly, the server augmenting gradient may be determined based on underlying client data without the underlying client data ever being transmitted to the remote system 160, and may be utilized to generate the augmented server gradient to enable fine-tuning of the global ML model based on mixed data sets (e.g., the client data 101 utilized in generating the gradient 103, and the additional server data utilized in generating the augmented server gradient) and while mitigating and/or preventing catastrophic forgetting of the global ML model.

In some implementations, the gradient 103 may be transmitted to the remote system, and optionally along with an indication of the global ML model(s) utilized to make a prediction based on the client data 101. In additional or alternative implementations, local ML training engine 132A may update the global ML model(s) 105 locally at the client device 110 and based on the gradient 103. In these implementations, the client device 110 may transmit one or more updated weights to the remote system 160, and optionally along with an indication of the global ML model(s) utilized to make a prediction based on the client data 101.

The remote ML training engine 162 can utilize the gradient 103 (and optionally one or more additional gradients 104 generated in the same or similar manner at one or more of the additional computing devices 170) to update one or more weights of the global ML model(s) 105 (e.g., stored in the global ML model(s) database 152B). For example, the remote ML training engine 162 can identify particular global ML model(s), from among one or more of the global ML models stored in the global ML model(s) database 152B, to update weights thereof. In some implementations, the remote ML training engine 162 can identify the particular global ML model based on the type of gradients that are received from the client devices (e.g., the client device 110 and/or one or more of the additional client device 170). For example, if a plurality of hotword gradients are received from the client devices, the remote ML training engine 162 can identify one or more global hotword detection models for updating based on the plurality of hotword gradients. As another example, if a plurality of audio-based gradients is received from the client devices, the remote ML training engine 162 can identify global audio-based model(s) for updating based on the plurality of audio-based gradients. Notably, the remote ML training engine 162 can identify a single global ML model to be updated at a given time instance or multiple global ML models to be updated, in parallel, at the given time instance.

In some implementations, the remote system 160 can assign the gradient 103 to a specific iteration of updating of one or more of the global ML models based on one or more criteria. The one or more criteria can include, for example, the types of gradients available to the remote ML training engine 162, a threshold quantity of gradients available to the remote ML training engine 162, a threshold duration of time of updating using the gradients, and/or other criteria. In particular, the remote ML training engine 162 can identify multiple sets or subsets of gradients generated by the client devices. Further, the remote ML training engine 162 can update one or more of the global ML models based on these sets or subsets of the gradients. In some further versions of those implementations, a quantity of gradients in the sets of client gradients and sets of remote gradients be the same or vary (e.g., proportional to one another and having either more client gradients or more remote gradients). In yet further versions of those implementations, each of the subsets of client gradients can optionally include client gradients from at least one unique client device that is not included in another one of the subsets. In other implementations, the remote system 160 may utilize the gradient 103 and other gradients to update one or more of the global ML models in a first in, first out (FIFO) manner without assigning any gradient to a specific iteration of updating of one or more of the global ML models.

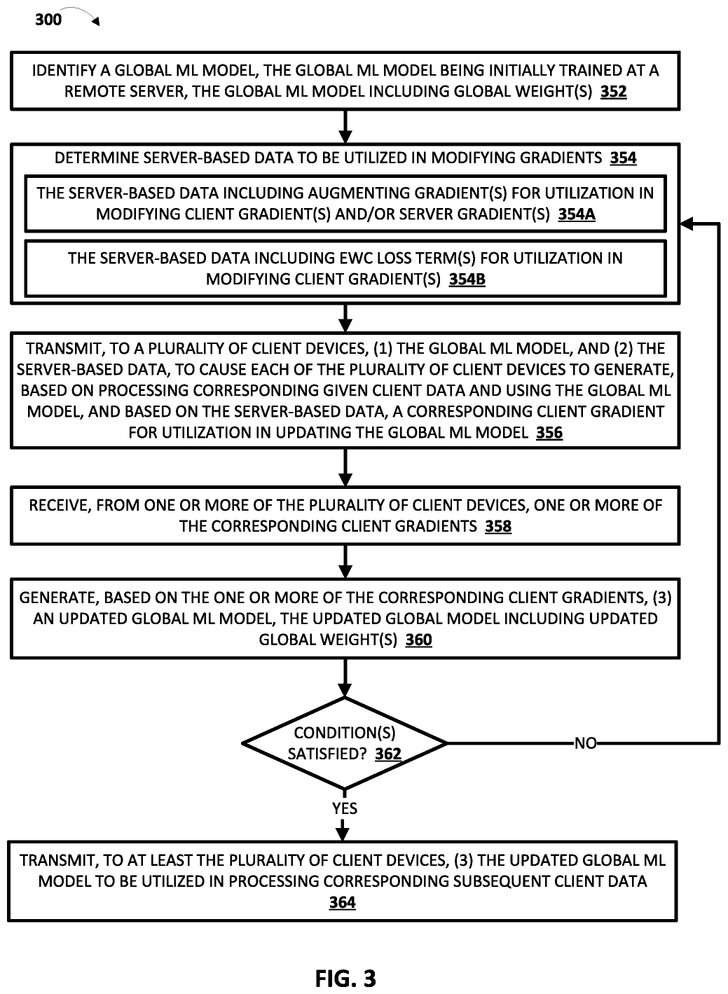

In various implementations, update distribution engine 166 can transmit one or more of the updated global ML models and/or one or more of the updated global weights thereof to the client devices. In some implementations, the update distribution engine 166 can transmit one or more of the updated global ML models and/or one or more of the updated global weights thereof to the client devices in response to one or more conditions being satisfied for the client devices and/or the remote system 160 (e.g., as described with respect to FIGS. 3-7). Upon receiving one or more of the updated global ML models and/or one or more of the updated global weights thereof, the client devices can replace one or more local ML models (e.g., stored in the local ML model(s) database 152A) with one or more of the updated global ML models, or replace one or more local weights of one or more of the local ML models with one or more of the updated global weights of the updated ML model(s). Further, the client devices may subsequently use one or more of the updated on-device ML model(s) to make predictions based on further client data for use in a subsequent iteration of training and/or for use at inference. The client devices may continue generating and transmitting gradients to the remote system 160 in the manner described herein to continue updating the global ML model(s).

Turning now to FIG. 2, a block diagram that demonstrates various aspects of the present is depicted. The block diagram of FIG. 2 includes a client device 210 having various on-device ML engines, that utilize various ML models that may be trained in the manner described herein, and that are included as part of (or in communication with) an automated assistant client 240. Other components of the client device 210 are not illustrated in FIG. 2 for simplicity. FIG. 2 illustrates one example of how the various on-device ML engines of and the respective ML models may be utilized by the automated assistant client 240 in performing various actions.

The client device 210 in FIG. 2 is illustrated with one or more microphones 211 for generating audio data, one or more speakers 212 for rendering audio data, one or more vision components 213 for generating vision data, and display(s) 214 (e.g., a touch-sensitive display) for rendering visual data and/or for receiving various touch and/or typed inputs. The client device 210 may further include pressure sensor(s), proximity sensor(s), accelerometer(s), magnetometer(s), and/or other sensor(s) that are used to generate other sensor data. The client device 210 at least selectively executes the automated assistant client 240. The automated assistant client 240 includes, in the example of FIG. 2, hotword detection engine 222, hotword free invocation engine 224, continued conversation engine 226, ASR engine 228, object detection engine 230, object classification engine 232, voice identification engine 234, and face identification engine 236. The automated assistant client 240 further includes speech capture engine 216 and visual capture engine 218. It should be understood that the ML engines and ML models depicted in FIG. 2 are provided for the sake of example to illustrate various ML models that may be trained in the manner described herein, and are not meant to be limiting. For example, the automated assistant client 240 can further include additional and/or alternative engines, such as a text-to-speech (TTS) engine and a respective TTS model, a voice activity detection (VAD) engine and a respective VAD model, an endpoint detector engine and a respective endpoint detector model, a lip movement engine and a respective lip movement model, and/or other engine(s) along with respective ML model(s). Moreover, it should be understood that one or more of the engines and/or models described herein can be combined, such that a single engine and/or model can perform the functions of multiple engines and/or models described herein.

One or more cloud-based automated assistant components 270 can optionally be implemented on one or more computing systems (collectively referred to as a “cloud” computing system) that are communicatively coupled to client device 210 via one or more networks as indicated generally by 299. The cloud-based automated assistant components 270 can be implemented, for example, via a high-performance remote server cluster of high-performance remote servers. In various implementations, an instance of the automated assistant client 240, by way of its interactions with one or more of the cloud-based automated assistant components 270, may form what appears to be, from a user's perspective, a logical instance of an automated assistant as indicated generally by 295 with which the user may engage in a human-to-computer interactions (e.g., spoken interactions, gesture-based interactions, typed-based interactions, and/or touch-based interactions). The one or more cloud-based automated assistant components 270 include, in the example of FIG. 2, cloud-based counterparts of the ML engines of the client device 210 described above, such as hotword detection engine 272, hotword free invocation engine 274, continued conversation engine 276, ASR engine 278, object detection engine 280, object classification engine 282, voice identification engine 284, and face identification engine 286. Again, it should be understood that the ML engines and ML models depicted in FIG. 2 are provided for the sake of example to illustrate various ML models that may be trained in the manner described herein, and are not meant to be limiting.

The client device 210 can be, for example: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television (or a standard television equipped with a networked dongle with automated assistant capabilities), and/or a wearable apparatus of the user that includes a computing device (e.g., a watch of the user having a computing device, glasses of the user having a computing device, a virtual or augmented reality computing device). Additional and/or alternative client devices may be provided.

The one or more vision components 213 can take various forms, such as monographic cameras, stereographic cameras, a LIDAR component (or other laser-based component(s)), a radar component, etc. The one or more vision components 213 may be used, e.g., by the visual capture engine 218, to capture vision data corresponding to vision frames (e.g., image frames, video frames, laser-based vision frames, etc.) of an environment in which the client device 210 is deployed. In some implementations, such vision frames can be utilized to determine whether a user is present near the client device 210 and/or a distance of a given user of the client device 210 relative to the client device 210. Such determination of user presence can be utilized, for example, in determining whether to activate one or more of the various on-device ML engines depicted in FIG. 2, and/or other engine(s). Further, the speech capture engine 216 can be configured to capture a user's spoken utterance(s) and/or other audio data captured via the one or more of the microphones 211, and optionally in response to receiving a particular input to invoke the automated assistant 295 (e.g., via actuation of a hardware or software button of the client device 210, via a particular word or phrase, via a particular gesture, etc.).

As described herein, such audio data and other non-audio data (collectively referred to herein as “client data”) can be processed by the various engines depicted in FIG. 2 to generate predicted output at the client device 210 using corresponding ML models and/or at one or more of the cloud-based automated assistant components 270 using corresponding ML models. Notably, the predicted output generated using the corresponding ML models may vary based on the client data (e.g., whether the client data is audio data, vision data, and/or other sensor data) and/or the corresponding ML models utilized in processing the client data.

As some non-limiting example, the respective hotword detection engines 222, 272 can utilize respective hotword detection models 222A, 272A to predict whether audio data includes one or more particular words or phrases to invoke the automated assistant 295 (e.g., “Ok Assistant”, “Hey Assistant”, “What is the weather Assistant?”, etc.) or certain functions of the automated assistant 295 (e.g., “Stop” to stop an alarm sounding or music playing or the like); the respective hotword free invocation engines 224, 274 can utilize respective hotword free invocation models 224A, 274A to predict whether non-audio data (e.g., vision data) includes a physical motion gesture or other signal to invoke the automated assistant 295 (e.g., based on a gaze of the user and optionally further based on mouth movement of the user); the respective continued conversation engines 226, 276 can utilize respective continued conversation models 226A, 276A to predict whether further audio data is directed to the automated assistant 295 (e.g., or directed to an additional user in the environment of the client device 210); the respective ASR engines 228, 278 can utilize respective ASR models 228A, 278A to generate recognized text, or predict phoneme(s) and/or token(s) that correspond to audio data detected at the client device 210 and generate the recognized text based on the phoneme(s) and/or token(s); the respective object detection engines 230, 280 can utilize respective object detection models 230A, 280A to predict object location(s) included in vision data captured at the client device 210; the respective object classification engines 232, 282 can utilize respective object classification models 232A, 282A to predict object classification(s) of object(s) included in vision data captured at the client device 210; the respective voice identification engines 234, 284 can utilize respective voice identification models 234, 284A to predict whether audio data captures a spoken utterance of one or more known users of the client device 210 (e.g., by generating a speaker embedding, or other representation, that can be compared to a corresponding actual embedding for the one or more known users of the client device 210); and the respective face identification engines 236, 286 can utilize respective face identification models 236A, 286A to predict whether vision data captures one or more known users of the client device 210 in an environment of the client device 210 (e.g., by generating a face embedding, or other representation, that can be compared to a corresponding face embedding for the one or more known users of the client device 210).

In some implementations, the client device 210 and one or more of the cloud-based automated assistant components 270 may further include natural language understanding (NLU) engines 238, 288 and fulfillment engine 240, 290, respectively. The NLU engines 238, 288 may perform natural language understanding and/or natural language processing utilizing respective NLU models 238A, 288A, on recognized text, predicted phoneme(s), and/or predicted token(s) generated by the ASR engines 228, 278 to generate NLU data. The NLU data can include, for example, intent(s) for a spoken utterance captured in audio data, and optionally slot value(s) for parameter(s) for the intent(s). Further, the fulfillment engines 240, 290 can generate fulfillment data utilizing respective fulfillment models or rules 240A, 290A, and based on processing the NLU data. The fulfillment data can, for example, define certain fulfillment that is responsive to user input (e.g., spoken utterances, typed input, touch input, gesture input, and/or any other user input) provided by a user of the client device 210. The certain fulfillment can include causing the automated assistant 295 to interact with software application(s) accessible at the client device 210, causing the automated assistant 295 to transmit command(s) to Internet-of-things (IoT) device(s) (directly or via corresponding remote system(s)) based on the user input, and/or other resolution action(s) to be performed based on processing the user input. The fulfillment data is then provided for local and/or remote performance/execution of the determined action(s) to cause the certain fulfillment to be performed.

In other implementations, the NLU engines 238, 288 and the fulfillment engines 240, 290 may be omitted, and the ASR engines 228, 278 can generate the fulfillment data directly based on the user input. For example, assume the ASR engines 228, 278 processes, using the respective ASR model 228A, 278A, a spoken utterance of “turn on the lights.” In this example, the ASR engines 228, 278 can generate a semantic output that is then transmitted to a software application associated with the lights and/or directly to the lights that indicates that they should be turned on without actively using the NLU engines 238, 288 and/or the fulfillment engines 240, 290 in processing the spoken utterance.

Notably, the one or more cloud-based automated assistant components 270 include cloud-based counterparts to the engines and models described herein with respect to the client device 210 of FIG. 2. However, in some implementations, these engines and models of the one or more cloud-based automated assistant components 270 may not be utilized since these engines and models may be transmitted directly to the client device 210 and executed locally at the client device 210. In other implementations, these engines and models may be utilized exclusively when the client device 210 detects any user input and transmits the user input to the one or more cloud-based automated assistant components 270. In various implementations, these engines and models executed at the client device 210 and the one or more cloud-based automated assistant components 270 may be utilized in conjunction with one another in a distributed manner. In these implementations, a remote execution module can optionally be included to perform remote execution using one or more of these engines and models based on local or remotely generated NLU data and/or fulfillment data. Additional and/or alternative remote engines can be included.

As described herein, in various implementations on-device speech processing, on-device image processing, on-device NLU, on-device fulfillment, and/or on-device execution can be prioritized at least due to the latency and/or network usage reductions they provide when resolving a spoken utterance (due to no client-server roundtrip(s) being needed to resolve the spoken utterance). However, one or more of the cloud-based automated assistant components 270 can be utilized at least selectively. For example, such component(s) can be utilized in parallel with on-device component(s) and output from such component(s) utilized when local component(s) fail. For example, if any of the on-device engines and/or models fail (e.g., due to relatively limited resources of client device 210), then the more robust resources of the cloud may be utilized.

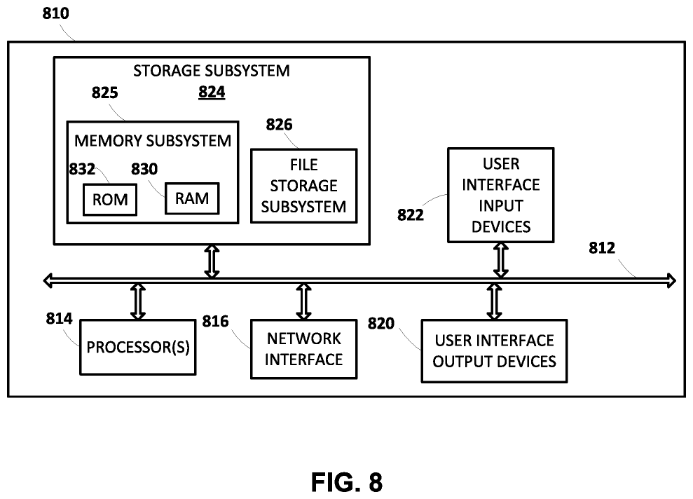

Turning now to FIG. 3, a flowchart illustrating an example method 300 of server-side aspects for utilizing server-based data in updating a global machine learning (ML) model is depicted. For convenience, the operations of the method 300 are described with reference to a system that performs the operations. The system of method 300 includes one or more processors and/or other component(s) of a computing device (e.g., the remote system 160 of FIG. 1, the cloud-based automated assistant component(s) 270 of FIG. 2, computing device 810 of FIG. 8, and/or other computing devices). Moreover, while operations of the method 300 are shown in a particular order, this is not meant to be limiting. One or more operations may be reordered, omitted, or added.

At block 352, the system identifies a global ML model, the global ML model being initially trained at a remote server, the global ML model including one or more global weights. In some implementations, the system may automatically identify the global ML model, from among a plurality of global ML models, based on one or more identification criteria. The one or more identification criteria can include, for example, whether the global ML model was initially trained at the remote server based on a server data, whether a duration of time that has elapsed since the global ML model was initially trained at the remote server, whether the global ML model has been previously fine-tuned based on corresponding client data, whether a duration of time that has elapsed since the global ML model was previously fine-tuned based on corresponding client data, and/or other identification criteria. For instance, if a global ML model has been recently trained at the remote server based on a server data set, but not yet fine-tuned based on a client data set, then the global ML model may be identified by the system at an iteration of block 652. In additional or alternative implementations, the system may identify the global ML model based on developer input (e.g., received via a developer client device of a developer) that is communication with the system. For example, the developer input may provide an indication of which global ML model, from among a plurality of global ML models, to identify at an iteration of block 652.

At block 354, the system determines server-based data to be utilized in modifying gradients. The server-based data may include any information that may be determined by the system at the remote server, and that may be utilized in modifying gradients.

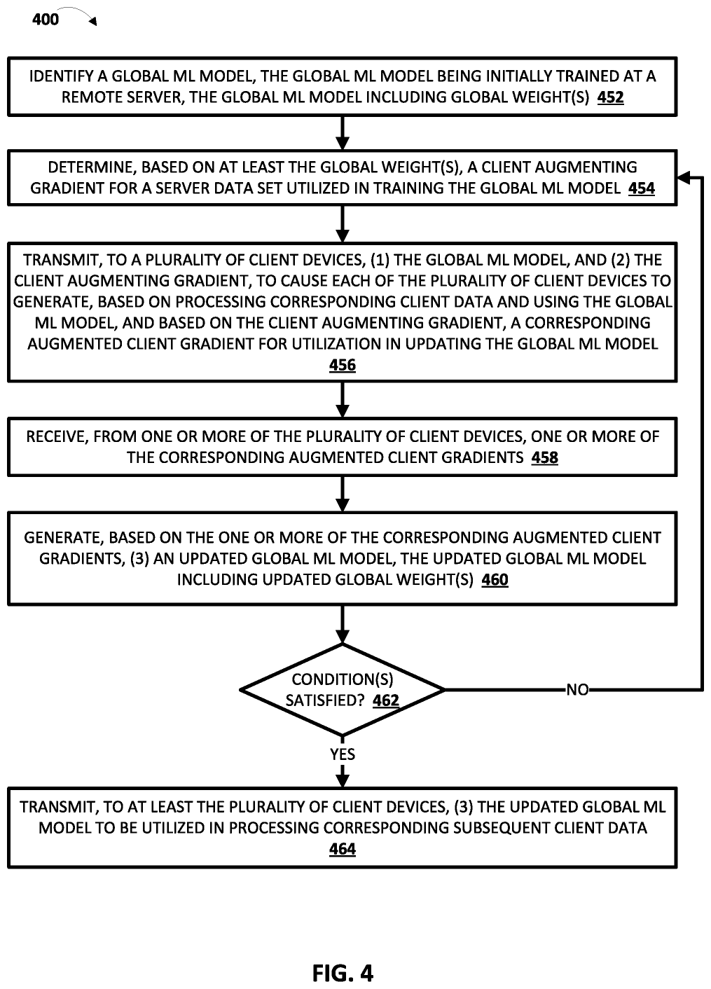

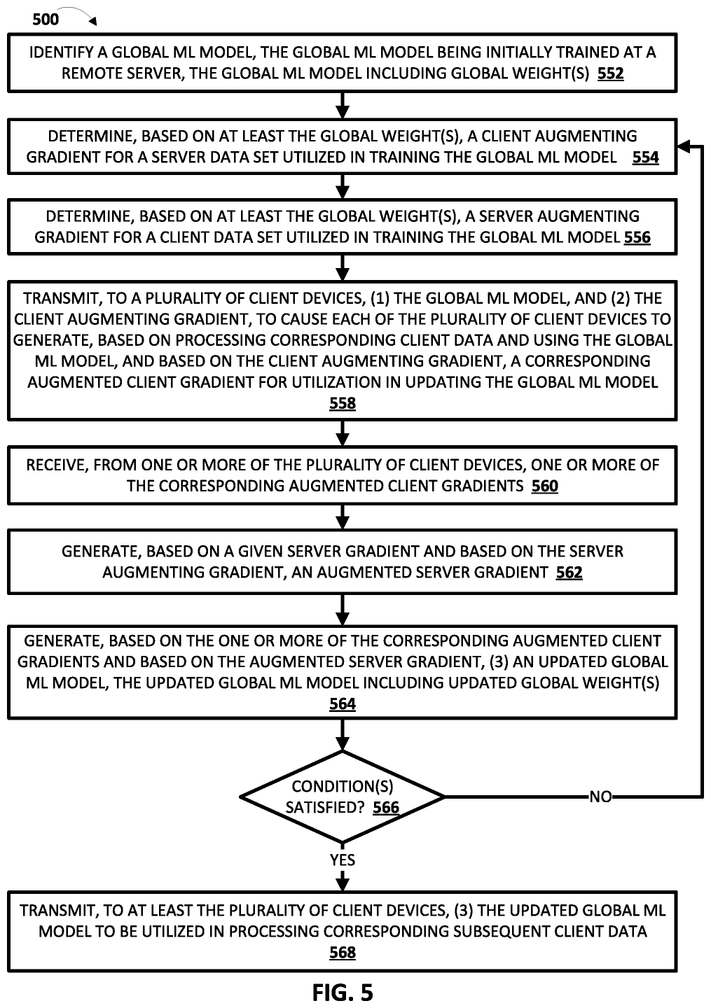

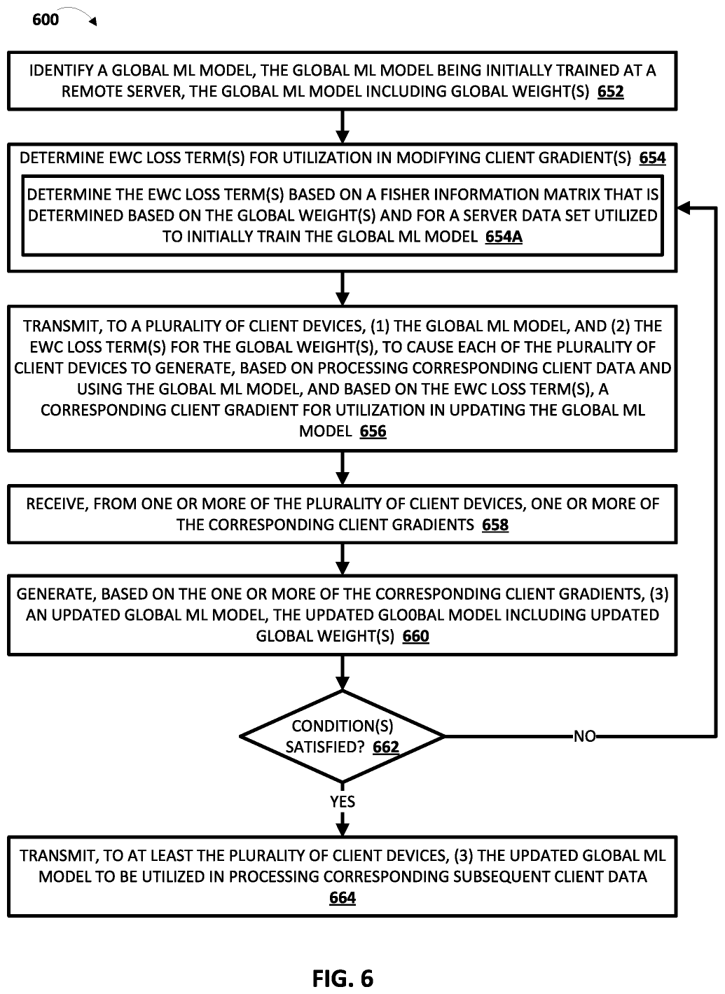

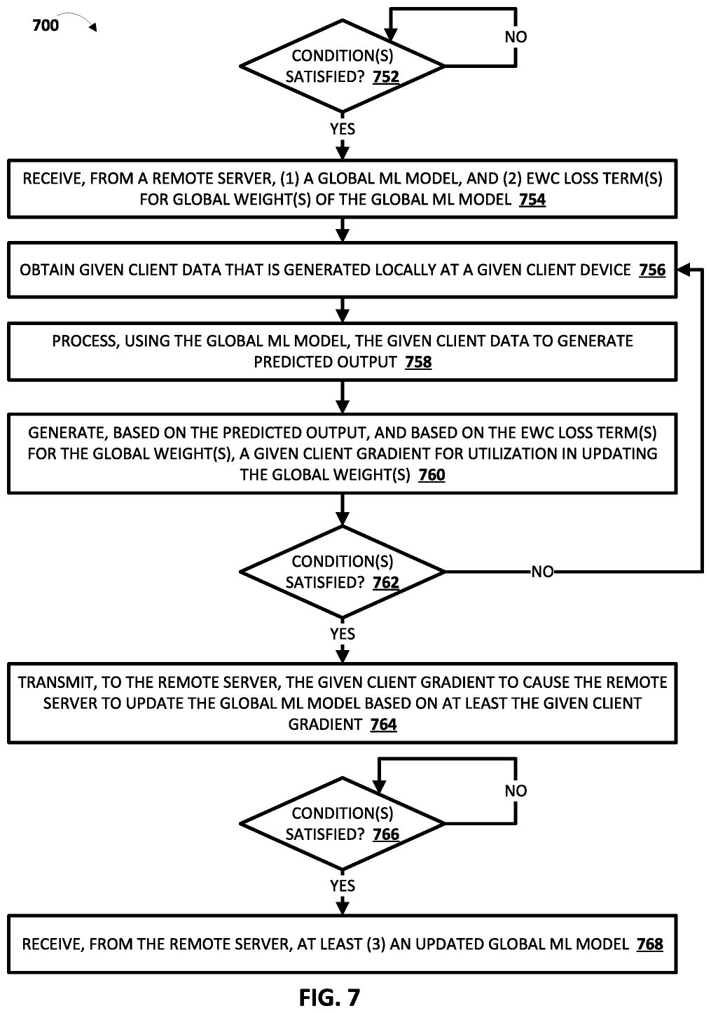

For example, and as indicated at block 354A, the server-based data may include one or more augmenting gradients for utilization in modifying one or more client gradients and/or one or more server gradients. For instance, determining and utilizing a client augmenting gradient in modifying the one or more client gradients is described in more detail herein with respect to a one-way gradient transfer technique (e.g., with respect to FIGS. 4 and 5). Also, for instance, determining and utilizing a server augmenting gradient in modifying one or more client gradients is described in more detail herein with respect to a two-way gradient transfer technique (e.g., with respect to FIG. 5). As another example, and as indicated at block 354B, the server-based data may include one or more elastic weight consolidation (EWC) loss terms for utilization in modifying one or more client gradients. For instance, determining and utilizing the one or more EWC loss terms in modifying the one or more client gradients is described in more detail herein (e.g., with respect to FIGS. 6 and 7).

At block 356, the system transmits, to a plurality of client devices, (1) the global ML model, and (2) the server-based data, to cause each of the plurality of client devices to generate, based on processing corresponding given client data and using the global ML model, and based on the server-based data, a corresponding client gradient for utilization in updating the global ML model. Notably, in transmitting the global ML model, the system may transmit the global ML model in its entirety, or transmit the one or more global weights of the global ML model without transmitting the global ML model in its entirety. In various implementations, the system may only transmit the (1) the global ML model and (2) the server-based data to a respective one of the plurality of client devices in response to receiving an indication, from the respective one of the plurality of client devices, that one or more conditions are satisfied at the respective one of the plurality of client devices. The one or more conditions can include, for example, a time of day, a day of week, whether the given client device is charging, whether the given client device has at least a threshold state of charge, whether a temperature of the given client device is less than a temperature threshold, whether the given client device is being held by a given user of the given client device, and/or other conditions. Put another way, the system may only transmit the (1) the global ML model and (2) the server-based data to a respective one of the plurality of client devices when the respective one of the plurality of client devices is available for receiving data from a remote server without negatively impacting usage and/or performance of the respective one of the plurality of client devices.

At block 358, the system receives, from one or more of the plurality of client devices, one or more of the corresponding client gradients. For example, the system may cause a given client device, of the plurality of client devices, to obtain given client data that is generated locally at the given client device in response to receiving (1) the global ML model and (2) the server-based data from the remote server. The given client data may include audio data generated by microphone(s) of the given client device, vision data generated by vision component(s) of the given client device, textual data generated via one or more interfaces of the given client device (e.g., a touchscreen display, a keyboard, etc.), and/or other client data. The given client data (or a type of the given client data) that is obtained by the system may be based on a type of the global ML model that is received at the given client device. For example, if the global ML model is a global audio-based ML model (e.g., global ASR model, global hotword detection model, global VAD model, etc.) that generates output based on processing audio data, then the given client data obtained may be audio data. As another example, if the global ML model is a global vision-based ML model (e.g., global object detection model, global object classification model, global hotword free invocation model, etc.) that generates output based on processing vision data, then the given client data obtained may be vision data. In some implementations, the system may cause the given client device to obtain the given data as it is generated locally at the given client device, whereas in other implementations, the system may cause the given client device to obtain the given client data from the on-device storage of the given client device.

Further, the system may cause the given client device to process, using the global ML model, the given client data to generate predicted output. For example, assume that the global ML model transmitted at block 356 is a global ASR model. In this example, the system may cause the given client device to obtain audio data as the given client data based on the global ASR model being an audio-based global ML model. Moreover, the system may cause the given client device to process, using the global ASR model, the audio data to generate, for instance, recognized text that is predicted to correspond to speech captured in the audio data as predicted output. As another example, assume that the global ML model transmitted at block 356 is a global object recognition model. In this example, the system may cause the given client device to obtain vision data as the given client data based on the global object recognition model being a vision-based global ML model. Moreover, the system may cause the given client device to process, using the global object recognition model, the vision data to generate, for instance, an indication of one or more recognized objects that are predicted to correspond to one or more objects captured in the vision data as predicted output. Additional, or alternative, global ML models may process additional, or alternative, client data to generate the predicted output as described herein (e.g., with respect to FIG. 2).

Moreover, the system causes the given client to generate, based on the predicted output, and based on the server-based data, a corresponding client gradient for utilization in updating the one or more global weights of the global ML model. The system may cause the given client device to generate a corresponding client gradient based on the predicted output using various supervised learning techniques and/or semi-supervised learning techniques. Further, the system may cause the given client device to modify or augment the corresponding client gradient with the server-based data, thereby generating the corresponding client gradient that is received at block 358. For instance, the corresponding client gradient may be a weighted or non-weighted combination of the corresponding client gradient generated using various supervised learning techniques and/or semi-supervised learning techniques and the server-based data received from the remote system.

At block 360, the system generates, based on the one or more of the corresponding client gradients, an updated global ML model, the updated global ML model including one or more updated global weights. In some implementations, the system may continually update the global ML model based on one or more of the corresponding client gradients as they are received from the plurality of client devices. In additional or alternative implementations, the system may wait until the one or more corresponding client gradients are received from each the plurality of client devices that are participating in the federated learning of the global ML model prior to generating the updated global ML model. In implementations where the one or more of the plurality of client devices update the global ML model locally based on the corresponding client gradients, the system may replace the one or more global weights of the global ML model with a combination of the one or more corresponding updated global weights that were updated locally at the one or more of the plurality of client devices.

At block 362, the system determines whether one or more conditions are satisfied. The one or more conditions may include, for example, whether a threshold quantity of gradients have been utilized in generating the updated global ML model, whether a threshold duration of time has elapsed since the updated global ML model was updated, whether performance of the updated global ML model (e.g., precision and/or recall) satisfies a threshold performance measure (e.g., precision measures and/or recall measures), and/or other conditions. Put another way, the system may determine whether the one or more conditions are satisfied to determine whether to keep updating the global ML model in a federated manner, or whether to deploy the updated global ML model for use locally at the plurality of client devices and/or additional client devices (e.g., as described with respect to FIG. 2).

If, at an iteration of block 362, the system determines that the one or more conditions are not satisfied, then the system may return to block 354 and continue with an additional iteration of the method 300 of FIG. 3. In executing the additional iteration of the method 300 of FIG. 3, the system may determine one or more updated server-based data to be utilized in modifying the one or more client gradients at an additional iteration of block 354, and the system may transmit, to the plurality of client device and/or additional client devices, (3) the updated global ML model, and (4) the updated server-based data, to cause each of the plurality of client devices to generate, based on processing corresponding additional client data and using the updated global ML model, and based on the updated server-based data, a corresponding additional client gradient for utilization in updating the updated global ML model at an additional iteration of block 356. Further, the system may receive, from one or more of the plurality of client devices and/or the additional client devices, one or more of the corresponding additional client gradients at an additional iteration of block 358, and the system may generate, based on the one or more of the corresponding additional client gradients, a further updated global ML model at an additional iteration of block 360. Moreover, the system may determine whether the one or more conditions are satisfied at an additional iteration of block 362. The system may continue updating the global ML model in this manner until it is determined that the one or more conditions are satisfied at an iteration of block 362.

If, at an iteration of block 362, the system determines that the one or more conditions are satisfied, then the system may proceed to block 364. At block 364, the system transmits, to at least the plurality of client devices, (3) the updated global ML model to be utilized in processing corresponding subsequent client data. In contrast with the global ML model that is transmitted to the plurality of client devices at block 356 (or an additional iteration thereof) that is utilized for training purposes (e.g., utilized in generating the corresponding client gradients), the updated global ML model transmitted to the plurality of client devices at block 364 may be utilized for inference purposes. Put another way, the global ML model that is transmitted to the plurality of client devices at block 356 may only be utilized in background processes of the plurality of client devices to generate the corresponding client gradients, whereas the updated global ML model transmitted to the plurality of client devices at block 364 may be utilized in foreground processes of the plurality of client devices to process the corresponding subsequent client data (e.g., as described with respect to FIG. 2).

Although the method 300 of FIG. 3 is described with respect to server-based data generally, it should be understood that is for the sake of example and FIGS. 4-6 provide more explicit examples of what the server-based data may include. However, it should be understood that FIGS. 4-6 provide a subset of techniques that may be utilized to mitigate and/or eliminate catastrophic forgetting of the global ML model. Accordingly, it should be understood that additional or alternative techniques to those described with respect to FIGS. 4-6 are also contemplated herein.

Further, although the method 300 of FIG. 3 and FIGS. 4-6 are described with respect to the global ML model being initially trained at the remote server, it should be understood that is for the sake of example. For example, in additional or alternative implementations, the global ML model may be initially trained in a federated manner and based on client data. In some versions of these implementations, the global ML model may be subsequently fine-tuned at the remote server and based on server data. In additional or alternative versions of these implementations, the global ML model may be subsequently fine-tuned based on client data in a concurrent manner with the fine-tuning based on the server data. In these implementations, the system may still utilize the server-based data in the same or similar manner described herein to mitigate and/or prevent catastrophic forgetting as the global ML model is fine-tuned based on these mixed data sources (e.g., the server data and the client data).

Turning now to FIG. 4, a flowchart illustrating an example method 400 of server-side aspects for utilizing a client augmenting gradient for a one-way gradient transfer technique in updating a global machine learning (ML) model is depicted. For convenience, the operations of the method 400 are described with reference to a system that performs the operations. The system of method 400 includes one or more processors and/or other component(s) of a computing device (e.g., the remote system 160 of FIG. 1, the cloud-based automated assistant component(s) 270 of FIG. 2, computing device 810 of FIG. 8, and/or other computing devices). Moreover, while operations of the method 400 are shown in a particular order, this is not meant to be limiting. One or more operations may be reordered, omitted, or added.

At block 452, the system identifies a global ML model, the global ML model being initially trained at a remote server, the global ML model including one or more global weights. The system may identify the global ML model in the same or similar manner described with respect to block 352 of the method 300 of FIG. 3.

At block 454, the system determines, based on at least the one or more global weights, a client augmenting gradient for a server data set utilized in training the global ML model. The client augmenting gradient may be subsequently utilized by the system to ensure that corresponding client gradients generated during an iteration of federated learning in the method 400 of FIG. 4 are augmented in a manner that mitigates and/or eliminates catastrophic forgetting of the global ML model. For instance, the client augmenting gradient may be utilized to augment the corresponding client gradients generated during an iteration of federated learning such that, when the global ML model is subsequently updated based on at least a corresponding augmented client gradient, the system minimizes the impact of client data utilized in generating the corresponding client gradients. In determining the client augmenting gradient for the server data set, the system may sample a batch of server data from the server data set that was utilized to initially train the global ML model. Further, the system may determine the client augmenting gradient with respect to the batch of server data and based on the one or more global weights of the global ML model as a stochastic gradient of a loss function for the global ML model.

At block 456, the system transmits, to a plurality of client devices, (1) the global ML model, and (2) the client augmenting gradient, to cause each of the plurality of client devices to generate, based on processing corresponding client data and using the global ML model, and based on the client augmenting gradient, a corresponding augmented client gradient for utilization in updating the global ML model. At block 458, the system receives, from one or more of the plurality of client devices, one or more of the corresponding augmented client gradients. In additional or alternative implementations, one or more of the plurality of client devices may update the global ML model locally based on the corresponding augmented client gradients, resulting in corresponding updated global ML models at each of the one or more of the plurality of client devices that each include one or more corresponding updated global weights. In these implementations, the system may receive the corresponding updated global ML models and/or the one or more corresponding updated global weights, rather than the one or more of the corresponding augmented client gradients.

For example, in transmitting the (1) the global ML model and (2) the client augmenting gradient to the plurality of client devices, the system may cause a given client device, of the plurality of client devices to obtain a given client data that is generated locally at the given client device. The given client data may include audio data generated by microphone(s) of the given client device, vision data generated by vision component(s) of the given client device, textual data generated via one or more interfaces of the given client device (e.g., a touchscreen display, a keyboard, etc.), and/or other client data. The given client data (or a type of the given client data) that is obtained by the system may be based on a type of the global ML model that is transmitted to the given client device at block 456.

For instance, if the global ML model is a global audio-based ML model (e.g., global ASR model, global hotword detection model, global VAD model, etc.) that generates output based on processing audio data, then the given client data obtained by the system may be audio data. As another example, if the global ML model is a global vision-based ML model (e.g., global object detection model, global object classification model, global hotword free invocation model, etc.) that generates output based on processing vision data, then the given client data obtained by the system may be vision data. As yet another example, if the global ML model is a global text-based ML model (e.g., a next word prediction model, a suggested textual reply model, etc.) that generates output based on processing textual data, then the given client data obtained by the system may be textual data. In some implementations, the given client data may be obtained as it is generated locally at the given client device, whereas in other implementations, the given client data may be obtained from the on-device storage of the given client device.

Further, the given client device may process, using the global ML model, the given client data to generate predicted output, and generate a corresponding client gradient based on at least the predicted output. For instance, assume that the global ML model transmitted to the given client device at block 456 is a global ASR model, and assume that the given client data obtained is audio data based on receiving the global ASR model. In this instance, the system may cause the given client device to process, using the global ASR model, the audio data to generate, for instance, recognized text that is predicted to correspond to speech captured in the audio data as the predicted output. Further, the system may further cause the given client device to generate a corresponding client gradient based on the recognized text and using various supervised learning techniques and/or semi-supervised learning techniques. Moreover, the system may generate the corresponding augmented client gradient as a weighted or non-weighted combination of the corresponding client gradient and the client augmenting gradient.

Also, for instance, assume that the global ML model transmitted to the given client device at block 456 is a global object recognition model, and assume that the given client data obtained is vision data based on receiving the global object recognition model. In this instance, the system may cause the given client device to process, using the global object recognition model, the vision data to generate, for instance, an indication of one or more recognized objects that are predicted to correspond to one or more objects captured in the vision data as the predicted output. Further, the system may further cause the given client device to generate a corresponding client gradient based on the indication of one or more recognized objects and using various supervised learning techniques and/or semi-supervised learning techniques. Moreover, the system may generate the corresponding augmented client gradient as a weighted or non-weighted combination of the corresponding client gradient and the client augmenting gradient.

Also, for instance, assume that the global ML model transmitted to the given client device at block 456 is a global next word prediction model, and assume that the given client data obtained is textual data based on receiving the global next word prediction model. In this instance, the system may cause the given client device to process, using the global next word prediction model, the textual data to generate, for instance, an indication of one or more next words that are predicted to correspond to one or more next words based on one or more prior words included in the textual data as the predicted output. Further, the system may further cause the given client device to generate a corresponding client gradient based on the indication of one or more next words and using various supervised learning techniques and/or semi-supervised learning techniques. Moreover, the system may generate the corresponding augmented client gradient as a weighted or non-weighted combination of the corresponding client gradient and the client augmenting gradient.

Notably, in various implementations, the given client device may generate a plurality of corresponding client gradients based on additional corresponding client data (e.g., additional audio data, additional vision data, and/or additional textual data in the above examples) and in response to the transmitting at block 456. In these implementations, each of the plurality of corresponding client gradients may be generated based on processing the corresponding additional client data using (1) the global ML model, and may be subsequently augmented, or otherwise modified, using (2) the client augmenting gradient to generate a plurality of corresponding augmented client gradients. In some versions of these implementations, each of the plurality of corresponding augmented client gradients may be aggregated locally at the given client device such that, at an iteration of block 460, the system receives a single corresponding augmented client gradient that captures the plurality of corresponding augmented client gradients that were aggregated locally at the given client device as a given aggregated augmented client gradient. In additional or alternative versions of those implementations, each of the plurality of corresponding augmented client gradients generated at the given client device may be received at an iteration of block 460 without any local aggregation thereof.

At block 460, the system generates, based on the one or more of the corresponding augmented client gradients, (3) an updated global ML model, the updated global ML model including one or more updated global weights. In some implementations, the system may continually update the global ML model based on one or more of the corresponding augmented client gradients as they are received from the plurality of client devices. In additional or alternative implementations, the system may wait until the one or more corresponding augmented client gradients are received from each the plurality of client devices that are participating in the federated learning of the global ML model prior to generating the updated global ML model. In implementations where the one or more of the plurality of client devices update the global ML model locally based on the corresponding augmented client gradients, the system may replace the one or more global weights of the global ML model with a combination of the one or more corresponding updated global weights that were updated locally at the one or more of the plurality of client devices.

At block 462, the system determines whether one or more conditions are satisfied. The one or more conditions may include, for example, the one or more conditions described above with respect to block 362 of the method 300 of FIG. 3. If, at an iteration of block 462, the system determines that the one or more conditions are not satisfied, then the system may return to block 454 and continue with an additional iteration of the method 400 of FIG. 4. In executing the additional iteration of the method 400 of FIG. 4, the system may determine an updated client augmenting gradient for the server data set based on at least the one or more updated global weights of the updated global ML model at an additional iteration of block 454, and the system may transmit, to the plurality of client device and/or additional client devices, (3) the updated global ML model, and (4) the updated client augmenting gradient, to cause each of the plurality of client devices to generate, based on processing corresponding additional client data and using the updated global ML model, and based on the updated client augmenting gradient, a corresponding additional augmented client gradient for utilization in updating the updated global ML model at an additional iteration of block 456. Further, the system may receive, from one or more of the plurality of client devices and/or the additional client devices, one or more of the corresponding additional augmented client gradients at an additional iteration of block 458, and the system may generate, based on the one or more of the corresponding additional augmented client gradients, a further updated global ML model at an additional iteration of block 460. Moreover, the system may determine whether the one or more conditions are satisfied at an additional iteration of block 462. The system may continue updating the global ML model in this manner until it is determined that the one or more conditions are satisfied at an iteration of block 462.

If, at an iteration of block 462, the system determines that the one or more conditions are satisfied, then the system may proceed to block 464. At block 464, the system transmits, to at least the plurality of client devices, (3) the updated global ML model to be utilized in processing corresponding subsequent client data. In contrast with the global ML model that is transmitted to the plurality of client devices at block 456 (or an additional iteration thereof) that is utilized for training purposes (e.g., utilized in generating the corresponding client gradients), the updated global ML model transmitted to the plurality of client devices at block 464 may be utilized for inference purposes. Put another way, the global ML model that is transmitted to the plurality of client devices at block 456 may only be utilized in background processes of the plurality of client devices to generate the corresponding client gradients, whereas the updated global ML model transmitted to the plurality of client devices at block 464 may be utilized in foreground processes of the plurality of client devices to process the corresponding subsequent client data (e.g., as described with respect to FIG. 2).

Although the method 400 of FIG. 4 is described with respect to a one-way gradient transfer technique to mitigate and/or eliminate catastrophic forgetting of the global ML model, it should be understood that is for the sake of example and is not meant to be limiting. Rather, and as described below with respect to FIG. 5, the system may additionally, or alternatively, utilize a two-way gradient transfer technique to mitigate and/or eliminate catastrophic forgetting of the global ML model, Further, and as described with respect to FIG. 6, the system may additionally, or alternatively, utilize an elastic weight consolidation (EWC) technique to mitigate and/or eliminate catastrophic forgetting of the global ML model.

Turning now to FIG. 5, a flowchart illustrating an example method 500 of server-side aspects for utilizing a client augmenting gradient and a server augmenting gradient for a two-way gradient transfer technique in updating a global machine learning (ML) model is depicted. For convenience, the operations of the method 500 are described with reference to a system that performs the operations. The system of method 500 includes one or more processors and/or other component(s) of a computing device (e.g., the remote system 160 of FIG. 1, the cloud-based automated assistant component(s) 270 of FIG. 2, computing device 810 of FIG. 8, and/or other computing devices). Moreover, while operations of the method 500 are shown in a particular order, this is not meant to be limiting. One or more operations may be reordered, omitted, or added.

At block 552, the system identifies a global ML model, the global ML model being initially trained at a remote server, the global ML model including one or more global weights. The system may identify the global ML model in the same or similar manner described with respect to block 352 of the method 300 of FIG. 3.

At block 554, the system determines, based on at least the one or more global weights, a client augmenting gradient for a server data set utilized in training the global ML model. The system may determine the client augmenting gradient in the same or similar manner described with respect to block 454 of the method 400 of FIG. 4.

At block 556, the system determines, based on at least the one or more global weights, a server augmenting gradient for a client data set utilized in training the global ML model. Accordingly, in the method 500 of FIG. 5 and in contrast with the method 400 of FIG. 4, the system additionally determines the server augmenting gradient for a client data set utilized in training the global ML model. The server augmenting gradient may be subsequently utilized by the system to ensure that corresponding server gradients generated during an iteration of federated learning in the method 500 of FIG. 5 are augmented in a manner that mitigates and/or eliminates catastrophic forgetting of the global ML model. Put another way, in the two-way gradient transfer technique of the method 500 of FIG. 5, the system determines both the client augmenting gradient and the server augmenting gradient for augmenting gradients generated at a plurality of client devices and at the remote server, respectively, rather than just the client augmenting gradient for augmenting gradients generated at the plurality of client devices as in the one-way gradient transfer technique of the method 400 of FIG. 4. For instance, the server augmenting gradient may be utilized to augment the corresponding server gradients generated during an iteration of federated learning such that, when the global ML model is subsequently updated based on at least a corresponding augmented client gradient and a corresponding augmented server gradient, the system minimizes the impact of server data utilized in generating a server gradient and client data utilized in generating the corresponding client gradients. In determining the server augmenting gradient for the client data set, the system may sample a batch of client data from the client data set that is utilized to fine-tune the global ML model. Further, the system may determine the server augmenting gradient with respect to the batch of client data and based on the one or more global weights of the global ML model as a stochastic gradient of a loss function for the global ML model.

At block 558, the system transmits, to a plurality of client devices, (1) the global ML model, and (2) the client augmenting gradient, to cause each of the plurality of client devices to generate, based on processing corresponding client data and using the global ML model, and based on the client augmenting gradient, a corresponding augmented client gradient for utilization in updating the global ML model. At block 560, the system receives, from one or more of the plurality of client devices, one or more of the corresponding augmented client gradients. The corresponding augmented client gradients may be generated in the same or similar manner described with respect to blocks 456 and 458 of the method 400 of FIG. 4. In additional or alternative implementations, one or more of the plurality of client devices may update the global ML model locally based on the corresponding augmented client gradients, resulting in corresponding updated global ML models at each of the one or more of the plurality of client devices that each include one or more corresponding updated global weights. In these implementations, the system may receive the corresponding updated global ML models and/or the one or more corresponding updated global weights, rather than the one or more of the corresponding augmented client gradients.

At block 562, the system generates, based on a given server gradient and based on the server augmenting gradient, an augmented server gradient. For example, the system may obtain given server data that is accessible at the remote server, process, using the global ML model, the given server data to generate server predicted output, generate the given server gradient based on the server predicted output, and generate the given augmented server gradient based on the given server gradient and the server augmenting gradient. Notably, the system may adapt the given server data and the processing thereof in the same or similar manner described with respect to the given augmented client gradient at blocks 456 and 458 of the method 400 of FIG. 4 based on a type of the given ML model (e.g., an audio-based global ML model, a vision-based global ML model, a text-based global ML model, and/or other types of global ML models). Similarly, the augments server gradient may be a weighted or non-weighted combination of the given server gradient and the server augmenting gradient.

Notably, in various implementations, the system may generate a plurality of corresponding server gradients based on additional server data (e.g., additional audio data, additional vision data, and/or additional textual data) and in response to the transmitting at block 456. In these implementations, each of the plurality of corresponding server gradients may be generated based on processing the additional server data using (1) the global ML model, and may be subsequently augmented, or otherwise modified, using the server augmenting gradient to generate a plurality of augmented server gradients. In some versions of these implementations, each of the plurality of server client gradients may be aggregated at the remote server such that, at an iteration of block 564, the system generates (3) the updated global ML model based on one or more of the corresponding augmented client gradients and based on the plurality of augmented server gradients. In additional or alternative versions of those implementations, the plurality of augmented server gradients may be aggregated remotely at the remote server prior to generating (3) the updated global ML model at an iteration of block 564.

At block 564, the system generates, based on the one or more of the corresponding augmented client gradients and based on the server augmenting gradient, (3) an updated global ML model, the updated global ML model including one or more updated global weights. In some implementations, the system may continually update the global ML model based on one or more of the corresponding augmented client gradients as they are received from the plurality of client devices. In additional or alternative implementations, the system may wait until the one or more corresponding augmented client gradients are received from each the plurality of client devices that are participating in the federated learning of the global ML model prior to generating the updated global ML model. In these implementations, the system may generate a corresponding augmented server gradient for each of the one or more corresponding augmented client gradients such that the system utilizes the same or similar quantity of augmented client gradients and augmented server gradients in updating the global ML model. In implementations where the one or more of the plurality of client devices update the global ML model locally based on the corresponding augmented client gradients, the system may replace the one or more global weights of the global ML model with a combination of the one or more corresponding updated global weights that were updated locally at the one or more of the plurality of client devices.

At block 566, the system determines whether one or more conditions are satisfied. The one or more conditions may include, for example, the one or more conditions described above with respect to block 362 of the method 300 of FIG. 3. If, at an iteration of block 566, the system determines that the one or more conditions are not satisfied, then the system may return to block 554 and continue with an additional iteration of the method 500 of FIG. 5. In executing the additional iteration of the method 500 of FIG. 5, the system may determine an updated client augmenting gradient for the server data set based on at least the one or more updated global weights of the updated global ML model at an additional iteration of block 554, the system may determine an updated server augmenting gradient for the client data set based on at least the one or more updated global weights of the updated global ML model at an additional iteration of block 556, and the system may transmit, to the plurality of client device and/or additional client devices, (3) the updated global ML model, and (4) the updated client augmenting gradient, to cause each of the plurality of client devices to generate, based on processing corresponding additional client data and using the updated global ML model, and based on the updated client augmenting gradient, a corresponding additional augmented client gradient for utilization in updating the updated global ML model at an additional iteration of block 558. Further, the system may receive, from one or more of the plurality of client devices and/or the additional client devices, one or more of the corresponding additional augmented client gradients at an additional iteration of block 560, the system may generate an additional augmented server gradient based on an additional server gradient and based on the updated server augmenting gradient at an additional iteration of block 562, and the system may generate, based on the one or more of the corresponding additional augmented client gradients and the additional augmented server gradient, a further updated global ML model at an additional iteration of block 564. Moreover, the system may determine whether the one or more conditions are satisfied at an additional iteration of block 566. The system may continue updating the global ML model in this manner until it is determined that the one or more conditions are satisfied at an iteration of block 566.

If, at an iteration of block 566, the system determines that the one or more conditions are satisfied, then the system may proceed to block 568. At block 568, the system transmits, to at least the plurality of client devices, (3) the updated global ML model to be utilized in processing corresponding subsequent client data. In contrast with the global ML model that is transmitted to the plurality of client devices at block 558 (or an additional iteration thereof) that is utilized for training purposes (e.g., utilized in generating the corresponding client gradients), the updated global ML model transmitted to the plurality of client devices at block 568 may be utilized for inference purposes. Put another way, the global ML model that is transmitted to the plurality of client devices at block 558 may only be utilized in background processes of the plurality of client devices to generate the corresponding client gradients, whereas the updated global ML model transmitted to the plurality of client devices at block 568 may be utilized in foreground processes of the plurality of client devices to process the corresponding subsequent client data (e.g., as described with respect to FIG. 2).

Turning now to FIG. 6, a flowchart illustrating an example method 600 of server-side aspects for utilizing elastic weight consolidation (EWC) loss terms in updating a global machine learning (ML) model is depicted. For convenience, the operations of the method 600 are described with reference to a system that performs the operations. The system of method 600 includes one or more processors and/or other component(s) of a computing device (e.g., the remote system 160 of FIG. 1, the cloud-based automated assistant component(s) 270 of FIG. 2, computing device 810 of FIG. 8, and/or other computing devices). Moreover, while operations of the method 600 are shown in a particular order, this is not meant to be limiting. One or more operations may be reordered, omitted, or added.

At block 652, the system identifies a global ML model, the global ML model being initially trained at a remote server, the global ML model including one or more global weights. The system may identify the global ML model in the same or similar manner described with respect to block 352 of the method 300 of FIG. 3.

At block 654, the system determines one or more EWC loss terms for utilization in modifying one or more client gradients. The one or more EWC loss terms may add a loss penalty that slows down learning of the one or more global weights of the global ML model (e.g., that are learned during the initial training of the global ML model based on the server data set) during the fine-tuning of the global ML model based on a client data set. Put another way, the one or more EWC loss terms ensures that the one or more global weights of the global ML model are not overfit when the global ML model is subsequently updated based on the client data set, thereby mitigating and/or eliminating catastrophic forgetting.

For example, and as indicated at block 654A, the system may determine the one or more EWC loss terms based on a Fisher information matrix that is determined based on the one or more global weights and for a server data set that is utilized to initially train the global ML model. In this example, the Fisher information seeks to measure the amount of information that an observable random variable carries about an unknown parameter of a distribution, and the Fisher information matrix may be computed as an expectation value of this measure and represented in matrix form (e.g., a Hessian matrix).

In some implementations, the system may determine the one or more EWC loss terms based on a diagonal of the Fisher information matrix. In some versions of these implementations, the system may utilize each corresponding value of the diagonal of the Fisher information matrix as a corresponding EWC loss term for a corresponding one of the one or more global weights. For instance, a first value of the diagonal of the Fisher information matrix (e.g., row 1, column 1) may be utilized as a first EWC loss term for a first global weight, a second value of the diagonal of the Fisher information matrix (e.g., row 2, column 2) may be utilized as a second EWC loss term for a second global weight, a third value of the diagonal of the Fisher information matrix (e.g., row 3, column 3) may be utilized as a third EWC loss term for a third global weight, and so on for each of the other global weights of the global ML model. In additional or alternative versions of these implementations, additional or alternative values or combinations of values may be utilized in determining the one or more EWC loss terms, such that a given EWC loss term may be utilized in updating multiple global weights of the one or more global weights and/or multiple EWC loss terms may be utilized in updating a given global weight of the one or more global weights, but that these implementations may not be as computationally efficient.

At block 656, the system transmits, to a plurality of client devices, (1) the global ML model, and (2) the one or more EWC loss terms for the one or more global weights, to cause each of the plurality of client devices to generate, based on processing corresponding client data and using the global ML model, and based on the one or more EWC loss terms, a corresponding client gradient for utilization in updating the global ML model. Notably, in transmitting the global ML model, the system may transmit the global ML model in its entirety, or transmit the one or more global weights of the global ML model without transmitting the global ML model in its entirety.

At block 658, the system receives, from one or more of the plurality of client devices, one or more corresponding client gradients. The client devices receiving (1) the global ML model, and (2) the one or more EWC loss terms for the one or more global weights, generating the corresponding client gradients based on processing the corresponding client data and using the global ML model, and based on the one or more EWC loss terms, and transmitting the corresponding client gradients back to the remote server is described in more detail herein (e.g., with respect to FIG. 7). In additional or alternative implementations, one or more of the plurality of client devices may update the global ML model locally based on the corresponding client gradients, resulting in corresponding updated global ML models at each of the one or more of the plurality of client devices that each include one or more corresponding updated global weights. In these implementations, the system may receive the corresponding updated global ML models and/or the one or more corresponding updated global weights.

At block 660, the system generates, based on the one or more of the corresponding client gradients, an updated global ML model, the updated global ML model including one or more updated global weights. In some implementations, the system may continually update the global ML model based on one or more of the corresponding client gradients as they are received from the plurality of client devices. In additional or alternative implementations, the system may wait until the one or more corresponding client gradients are received from each the plurality of client devices that are participating in the federated learning of the global ML model prior to generating the updated global ML model. In implementations where the one or more of the plurality of client devices update the global ML model locally based on the corresponding client gradients, the system may replace the one or more global weights of the global ML model with a combination of the one or more corresponding updated global weights that were updated locally at the one or more of the plurality of client devices.

At block 662, the system determines whether one or more conditions are satisfied. The one or more conditions may include, for example, whether a threshold quantity of gradients have been utilized in generating the updated global ML model, whether a threshold duration of time has elapsed since the updated global ML model was updated, whether performance of the updated global ML model (e.g., precision and/or recall) satisfies a threshold performance measure (e.g., precision measures and/or recall measures). Put another way, the system may determine whether the one or more conditions are satisfied to determine whether to keep updating the global ML model in a federated manner, or whether to deploy the updated global ML model for use locally at the plurality of client devices and/or additional client devices (e.g., as described with respect to FIG. 2).

If, at an iteration of block 662, the system determines that the one or more conditions are not satisfied, then the system may return to block 654 and continue with an additional iteration of the method 600 of FIG. 6. In executing the additional iteration of the method 600 of FIG. 6, the system may determine one or more updated EWC loss terms for utilization in modifying the one or more client gradients at an additional iteration of block 654, and the system may transmit, to the plurality of client device and/or additional client devices, (3) the updated global ML model, and (4) the one or more updated EWC for the one or more updated global weights, to cause each of the plurality of client devices to generate, based on processing corresponding additional client data and using the updated global ML model, and based on the one or more updated EWC loss terms, a corresponding additional client gradient for utilization in updating the updated global ML model at an additional iteration of block 656. Further, the system may receive, from one or more of the plurality of client devices and/or the additional client devices, one or more of the corresponding additional client gradients at an additional iteration of block 658, and the system may generate, based on the one or more of the corresponding additional client gradients, a further updated global ML model at an additional iteration of block 660. Moreover, the system may determine whether the one or more conditions are satisfied at an additional iteration of block 662. The system may continue updating the global ML model in this manner until the one or more conditions are satisfied at an iteration of block 662.

If, at an iteration of block 662, the system determines that the one or more conditions are satisfied, then the system may proceed to block 664. At block 664, the system transmits, to at least the plurality of client devices, the updated global ML model to be utilized in processing corresponding subsequent client data. In contrast with the global ML model that is transmitted to the plurality of client devices at block 656 (or an additional iteration thereof) that is utilized for training purposes (e.g., utilized in generating the corresponding client gradients), the updated global ML model transmitted to the plurality of client devices at block 664 may be utilized for inference purposes. Put another way, the global ML model that is transmitted to the plurality of client devices at block 656 may only be utilized in background processes of the plurality of client devices to generate the corresponding client gradients, whereas the updated global ML model transmitted to the plurality of client devices at block 664 may be utilized in foreground processes of the plurality of client devices to process the corresponding subsequent client data (e.g., as described with respect to FIG. 2).

Although the method 600 of FIG. 6 is only described with respect to a single global ML model, it should be understood that is for the sake of example and is not meant to be limiting. For example, it should be understood that multiple iterations of the method 600 of FIG. 6 may be performed, in a parallel manner or serial manner, with respect to multiple global ML models. Further, although the method 600 of FIG. 6 is only described with respect to the server-side aspects for utilizing the one or more EWC loss terms in updating the global ML model, it should also be understood that is for the sake of example and is not meant to be limiting. For example, FIG. 7 is described below with respect to client-side aspects for utilizing the one or more EWC loss terms in updating the global ML model.

Turning now to FIG. 7, a flowchart illustrating an example method 700 of client-side aspects for utilizing elastic weight consolidation (EWC) loss terms in updating a global machine learning (ML) model is depicted. For convenience, the operations of the method 700 are described with reference to a system that performs the operations. The system of method 700 includes one or more processors and/or other component(s) of a computing device (e.g., the client device 110 of FIG. 1, the client device 210 of FIG. 2, computing device 810 of FIG. 8, and/or other computing devices). Moreover, while operations of the method 700 are shown in a particular order, this is not meant to be limiting. One or more operations may be reordered, omitted, or added.

At block 752, the system determines whether one or more conditions are satisfied at a given client device. The one or more conditions can include, for example, a time of day, a day of week, whether the given client device is charging, whether the given client device has at least a threshold state of charge, whether a temperature of the given client device is less than a temperature threshold, whether the given client device is being held by a given user of the given client device, and/or other conditions. Put another way, the system may determine whether the one or more conditions are satisfied at block 752 to determine whether the given client device is available for receiving data from a remote server without negatively impacting usage and/or performance of the given client device. If, at an iteration of block 752, the system determines that the one or more conditions are not satisfied, then the system may continue monitoring for satisfaction of the one or more conditions at block 752. If, at an iteration of block 752, the system determines that the one or more conditions are satisfied, then the system may proceed to block 754.

At block 754, the system receives, from a remote server, (1) a global ML model, and (2) one or more EWC loss terms for one or more global weights of the global ML model. The global ML model that is received may be identified in the same manner described with respect to block 652 of the method 600 of FIG. 6. Further, the one or more EWC loss terms for the one or more global weights of the global ML model may be determined in the same manner described with respect to block 654 of the method 600 of FIG. 6. The system may cause the given client device to store the global ML model and the one or more EWC loss terms in on-device storage of the given client device. In instances where the given client device already has an instance of the global ML model stored in the on-device storage (e.g., from a prior iteration of training the global ML model is a federated manner), the system may cause the given client device to replace, in the on-device storage, the instance of the global ML model with the ML model (or the one or more global weights thereof) with the global ML model (or the one or more global weights thereof) that is received at block 754.

At block 756, the system obtains given client data that is generated locally at a given client device. The given client data may include audio data generated by microphone(s) of the given client device, vision data generated by vision component(s) of the given client device, textual data generated via one or more interfaces of the given client device (e.g., a touchscreen display, a keyboard, etc.), and/or other client data. The given client data (or a type of the given client data) that is obtained by the system may be based on a type of the global ML model that is received at block 754. For example, if the global ML model is a global audio-based ML model (e.g., global ASR model, global hotword detection model, global VAD model, etc.) that generates output based on processing audio data, then the given client data obtained by the system may be audio data. As another example, if the global ML model is a global vision-based ML model (e.g., global object detection model, global object classification model, global hotword free invocation model, etc.) that generates output based on processing vision data, then the given client data obtained by the system may be vision data. In some implementations, the system may obtain the given client data as it is generated locally at the given client device, whereas in other implementations, the system may obtain the given client data from the on-device storage of the given client device.

At block 758, the system processes, using the global ML model, the given client data to generate predicted output. For example, assume that the global ML model received at block 754 is a global ASR model, and assume that the given client data obtained at block 756 is audio data based on receiving the global ASR model. In this example, the system may process, using the global ASR model, the audio data to generate, for instance, recognized text that is predicted to correspond to speech captured in the audio data as the predicted output. As another example, assume that the global ML model received at block 754 is a global object recognition model, and assume that the given client data obtained at block 756 is vision data based on receiving the global object recognition model. In this example, the system may process, using the global object recognition model, the vision data to generate, for instance, an indication of one or more recognized objects that are predicted to correspond to one or more objects captured in the vision data as the predicted output. Additional, or alternative, global ML models may process additional, or alternative, client data to generate the predicted output as described herein (e.g., with respect to FIG. 2).

At block 760, the system generates, based on the predicted output, and based on the one or more EWC loss terms for the one or more global weights, a given client gradient for utilization in updating the one or more global weights. The system may generate a client gradient based on the predicted output using various supervised learning techniques and/or semi-supervised learning techniques. Further, the system may generate the given client gradient as a weighted or non-weighted combination of the client gradient and the one or more EWC loss terms. In generating the given client gradient, and by utilizing the one or more EWC loss terms, deviations to the one or more global weights may be penalized to ensure that the given client gradient, when subsequently utilized in updating the global ML model, does not cause the updated global ML model to catastrophically forget information learned in the initial training of the global ML model based on the server data set. Notably, the client gradient may include a vector of values that is utilized to update the one or more global weights of the global ML model. Accordingly, the system can combine the vector of values with the one or more EWC loss terms to generate the given client gradient.

In some implementations, in generating the given client gradient, the system can combine a first value, of the vector of values corresponding to the client gradient, with a first EWC loss term, of the one or more EWC loss terms, a second value, of the vector of values corresponding to the client gradient, with a second EWC loss term, of the one or more EWC loss terms, and so on for each of the values of the client gradient and each of the one or more EWC loss terms to generate the given client gradient. In some versions of those implementations, the corresponding values and EWC loss terms may be added together, and optionally weighted. In additional or alternative implementations, in generating the given client gradient, the system can combine multiple values, of the vector of values corresponding to the client gradient, with a given EWC loss term, of the one or more EWC loss terms, and/or combine a given value, of the vector of values corresponding to the client gradient, with multiple EWC loss terms, of the one or more EWC loss terms.

At block 762, the system determines whether one or more conditions are satisfied. The one or more conditions can include, for example, the one or more conditions described above with respect to block 752. Put another way, the system may determine whether the one or more conditions are satisfied at block 762 to determine whether the given client device is available for transmitting data to the remote server without negatively impacting usage and/or performance of the given client device.

If, at an iteration of block 762, the system determines that the one or more conditions are not satisfied, then the system may return to block 756 and continue with an additional iteration of the method 700 of FIG. 7. In executing the additional iteration of the method 700 of FIG. 7, the system may obtain given additional client data (e.g., that is in addition to the given client data obtained at the initial iteration of block 756) at an additional iteration of block 756, the system may process, using the global ML model, the given additional client data to generate additional predicted output and an additional iteration of block 758, and the system may generated, based on the additional predicted output, and based on the one or more EWC loss terms for the one or more global weights, a given additional client gradient for utilization in updating the one or more global weights. Further, the system may determine whether the one or more conditions are satisfied at an additional iteration of block 762. The system may continue generating given client gradients in this manner until the one or more conditions are satisfied at an iteration of block 762. Additionally, or alternatively, the system may refrain from executing the additional iteration of the method 700 of FIG. 7, and simply monitor for satisfaction of the one or more conditions at block 762. If, at an iteration of block 762, the system determines that the one or more conditions are satisfied, then the system may proceed to block 464.

At block 764, the system transmits, to the remote server, the given client gradient to cause the remote server to update the global ML model based on at least the given client gradient. In additional or alternative implementations, the given client device may generate an updated global ML model locally at the given client device by updating the global ML model based on the given client gradient. In these implementations, the system may transmit the one or more updated global weights, of the global ML model, to the remote server.

At block 766, the system determines whether one or more conditions are satisfied. The one or more conditions can include, for example, the one or more conditions described above with respect to block 752. Put another way, the system may determine whether the one or more conditions are satisfied at block 766 to determine whether the given client device is available for receiving data from a remote server without negatively impacting usage and/or performance of the given client device. If, at an iteration of block 766, the system determines that the one or more conditions are not satisfied, then the system may continue monitoring for satisfaction of the one or more conditions at block 766. If, at an iteration of block 766, the system determines that the one or more conditions are satisfied, then the system may proceed to block 468.

At block 768, the system receives, from the remote server, at least (3) an updated global ML model. Notably, at an additional iteration of block 754 and at an iteration of block 768, the system may receive the updated global ML model from the remote server. However, at the additional iteration of block 754, the system may further receive one or more updated EWC loss terms for one or more updated global weights of the updated global ML model. Upon receiving the updated global ML model along the one or more updated EWC loss terms, the system may infer that the global ML model is still being trained in a federated manner. In contrast, upon receiving the global ML model without the one or more updated EWC loss terms, the system may infer that the given client device should deploy the global ML model for use in processing subsequent client data. Additionally, or alternatively, the remote server may transmit instructions of how the given client device should utilize the global ML model (e.g., for training in a federated manner, or for inference locally at the given client device).

Although the method 700 of FIG. 7 is only described with respect to a single client device, it should be understood that is for the sake of example and is not meant to be limiting. For example, it should be understood that respective iterations of the method 700 of FIG. 7 may be performed, in a parallel manner or serial manner, with respect to additional client devices. Further, although the method 700 of FIG. 7 is only described with respect to a single global ML model, it should be understood that is for the sake of example and is not meant to be limiting. For example, it should be understood that multiple iterations of the method 700 of FIG. 7 may be performed, in a parallel manner or serial manner, with respect to multiple global ML models.

Turning now to FIG. 8, a block diagram of an example computing device 810 that may optionally be utilized to perform one or more aspects of techniques described herein is depicted. In some implementations, one or more of a client device, cloud-based automated assistant component(s), and/or other component(s) may comprise one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of the methods disclosed herein, as well as to implement various components depicted in FIGS. 1 and 2.

These software modules are generally executed by processor 814 alone or in combination with other processors. Memory 825 used in the storage subsystem 824 can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method performed by one or more processors of a client device is provided and includes identifying, at a remote server, a global machine learning (ML) model, the global ML model being initially trained at the remote server, and the global ML model including one or more global weights; determining, at the remote server, and based on at least the one or more global weights, a client augmenting gradient for a server data set utilized in training the global ML model; determining, at the remote server, and based on at least the one or more global weights, a server augmenting gradient for a client data set utilized in training the global ML model; and transmitting, from the remote server and to a plurality of client devices, (i) the global ML model, and (ii) the client augmenting gradient. Transmitting (i) the global ML model, and (ii) the client augmenting gradient to a given client device, of the plurality of client devices, causes the given client device to: generate, based on processing given client data locally at the given client device and using the global ML model, a given client gradient for utilization in updating the one or more global weights; generate, based on the given client gradient and based on the client augmenting gradient, a given augmented client gradient; and transmit, to the remote server and from the given client device, the given augmented client gradient. The method further includes generating, based on a given server gradient and the server augmenting gradient, a given augmented server gradient; and generating, based on the given augmented client gradient and the given augmented server gradient, an updated global ML model, the updated global ML model including one or more updated global weights.

These and other implementations of the technology can include one or more of the following features.

In some implementations, transmitting (i) the global ML model, and (ii) the client augmenting gradient to a given additional client device, of the plurality of client devices and in addition to the given client device, may cause the given additional client device to: generate, based on processing given additional client data locally at the given additional client device and using the global ML model, a given additional client gradient for utilization in updating the one or more global weights; generate, based on the given additional client gradient and based on the client augmenting gradient, a given additional augmented client gradient; and transmit, to the remote server and from the given additional client device, the given additional augmented client gradient. In some versions of those implementations, generating the updated global ML model may be further based on the given additional augmented client gradient and the given additional augmented server gradient.

In some implementations, transmitting (i) the global ML model, and (ii) the client augmenting gradient to the given client device may further cause the given client device to: generate, based on processing corresponding additional given additional client data locally at the given client device and using the global ML model, a plurality of corresponding given additional client gradients for utilization in updating the one or more global weights; generate, based on the given plurality of corresponding given additional client gradients and based on the client augmenting gradient, a plurality of corresponding given additional augmented client gradients; and aggregate the given augmented client gradient and the plurality of corresponding given additional augmented client gradients to generate a given aggregated augmented client gradient. The given augmented client gradient transmitted to the remote system may be the given aggregated augmented client gradient.

In some implementations, the method may further include generating the given server gradient based on processing additional server data, that is in addition to server data included in the server data set utilized to initially train the global ML model, using the global ML model.

In some implementations, the method may further include determining, at the remote server, and based on at least the one or more updated global weights, an updated server augmenting gradient for the client data set utilized in training the global ML model; determining, at the remote server, and based on at least the one or more updated global weights, an updated client augmenting gradient for the server data set utilized in training the global ML model; and transmitting, from the remote server and to a plurality of client devices, (iii) the updated global ML model, and (iv) the updated client augmenting gradient. Transmitting (iii) the updated global ML model, and (iv) the updated client augmenting gradient to the given client device may cause the given client device to: generate, based on processing additional given client data locally at the given client device and using the updated global ML model, a given additional client gradient for utilization in further updating the one or more updated global weights; generate, based on the given additional client gradient and based on the updated client augmenting gradient, a given additional augmented client gradient; and transmit, to the remote server and from the given client device, the given additional augmented client gradient. The method may further include generating, based on an additional server gradient and the updated server augmenting gradient, a given additional augmented server gradient; and generating, based on the given additional augmented client gradient and the given additional augmented server gradient, a further updated global ML model, the further updated global ML model including one or more further updated global weights.

In some implementations, the given augmented client gradient may be a weighted or non-weighted sum of the given client gradient and the client augmenting gradient. In some versions of those implementations, the given augmented server gradient may be a weighted or non-weighted sum of the given server gradient and the server augmenting gradient.

In some implementations, the method may further include determining, at the remote server, whether one or more conditions are satisfied; and in response to determining that the one or more conditions are satisfied: transmitting, from the remote server and to the plurality of client devices, (iii) the updated global ML model. Transmitting (iii) the updated global ML model to the given client device may cause the given client device to: store, in on-device storage of the given client device, the updated global ML model; and cause the updated global ML model to be utilized in processing subsequent client data locally at the given client device. In some versions of those implementations, the one or more conditions may include one or more of: a threshold quantity of gradients being utilized in generating the updated ML model, a threshold duration of time elapsing, or a threshold performance measure being satisfied by the updated global ML model.

In some implementations, transmitting the global ML model to the given client device may cause the given client device to: store, in on-device storage of the given client device the one or more global weights of the global ML model.

In some implementations, the global ML model may be an audio-based global ML model that is utilized in processing audio data.

In some implementations, the global ML model may be a vision-based global ML model that is utilized in processing vision data.

In some implementations, a method performed by one or more processors of a client device is provided and includes, at a remote server: identifying a global machine learning (ML) model, the global ML model being initially trained at the remote server, and the global ML model including one or more global weights; determining, based on at least the one or more global weights, a server augmenting gradient for a client data set utilized in training the global ML model; determining, based on at least the one or more global weights, a client augmenting gradient for a server data set utilized in training the global ML model; and transmitting, to a plurality of client devices, (i) the global ML model, and (ii) the client augmenting gradient. The method further includes, at a given client device of the plurality of client devices: receiving (i) the global ML model, and (ii) the client augmenting gradient; obtaining given client data that is generated locally at the given client device; processing, using the global ML model, the client data to generate client predicted output; generating, based on the client predicted output, a given client gradient; generating, based on the given client gradient and based on the client augmenting gradient, a given augmented client gradient; and transmitting, to the remote server, the given augmented client gradient; and at the remote server: receiving the given augmented client gradient; obtaining given server data that is accessible at the remote server; processing, using the global ML model, the given server data to generate server predicted output; generating, based on the server predicted output, a given server gradient; generating, based on the given server gradient and the server augmenting gradient, a given augmented server gradient; and generating, based on at least the given augmented client gradient and the given augmented server gradient, an updated global ML model, the updated global ML model including one or more updated global weights.

In some implementations, a method performed by one or more processors of a client device is provided and includes identifying, at a remote server, a global machine learning (ML) model, the global ML model being initially trained at the remote server, and the global ML model including one or more global weights; determining, at the remote server, and based on at least the one or more global weights, a client augmenting gradient for a server data set utilized in training the global ML model; and transmitting, from the remote server and to a plurality of client devices, (i) the global ML model, and (ii) the client augmenting gradient. Transmitting (i) the global ML model, and (ii) the client augmenting gradient to a given client device, of the plurality of client devices, causes the given client device to: generate, based on processing given client data locally at the given client device and using the global ML model, a given client gradient for utilization in updating the one or more global weights; generate, based on the given client gradient and based on the client augmenting gradient, a given augmented client gradient; and transmit, to the remote server and from the given client device, the given augmented client gradient. The method further includes generating, based on at least the given augmented client gradient, an updated global ML model, the updated global ML model including one or more updated global weights.

These and other implementations of the technology can include one or more of the following features.

In some implementations, transmitting (i) the global ML model, and (ii) the client augmenting gradient to a given additional client device, of the plurality of client devices and in addition to the given client device, may cause the given additional client device to: generate, based on processing given additional client data locally at the given additional client device, a given additional client gradient for utilization in updating the one or more global weights; generate, based on the given additional client gradient and based on the client augmenting gradient, a given additional augmented client gradient; and transmit, to the remote server and from the given additional client device, the given additional augmented client gradient. In some versions of those implementations, generating the updated global ML model may be further based on the given additional augmented client gradient and the given additional augmented client gradient.

In some implementations, transmitting (i) the global ML model, and (ii) the client augmenting gradient to the given client device may further cause the given client device to: generate, based on processing corresponding additional given additional client data locally at the given client device and using the global ML model, a plurality of corresponding given additional client gradients for utilization in updating the one or more global weights; generate, based on the given plurality of corresponding given additional client gradients and based on the client augmenting gradient, a plurality of corresponding given additional augmented client gradients; and aggregate the given augmented client gradient and the plurality of corresponding given additional augmented client gradients to generate a given aggregated augmented client gradient. The given augmented client gradient transmitted to the remote system may be the given aggregated augmented client gradient.

In some implementations, the method may further include determining, at the remote server, and based on at least the one or more updated global weights, an updated client augmenting gradient for the server data set utilized in training the global ML model; and transmitting, from the remote server and to a plurality of client devices, (iii) the updated global ML model, and (iv) the updated client augmenting gradient. Transmitting (iii) the updated global ML model, and (iv) the updated client augmenting gradient to the given client device may cause the given client device to: generate, based on processing additional given client data locally at the given client device and using the updated global ML model, a given additional client gradient for utilization in further updating the one or more updated global weights; generate, based on the given additional client gradient and based on the updated client augmenting gradient, a given additional augmented client gradient; and transmit, to the remote server and from the given client device, the given additional augmented client gradient. The method may further include generating, based on at least the given additional augmented client gradient, a further updated global ML model, the further updated global ML model including one or more further updated global weights.

In some implementations, the given augmented client gradient may be a weighted or non-weighted sum of the given client gradient and the client augmenting gradient.

In some implementations, the method may further include determining, at the remote server, whether one or more conditions are satisfied; and in response to determining that the one or more conditions are satisfied: transmitting, from the remote server and to the plurality of client devices, (iii) the updated global ML model. Transmitting (iii) the updated global ML model to the given client device may cause the given client device to: store, in on-device storage of the given client device, the updated global ML model; and cause the updated global ML model to be utilized in processing subsequent client data locally at the given client device. In some versions of those implementations, the one or more conditions may include one or more of: a threshold quantity of gradients being utilized in generating the updated ML model, a threshold duration of time elapsing, or a threshold performance measure being satisfied by the updated global ML model.

In some implementations, transmitting the global ML model to the given client device may cause the given client device to: store, in on-device storage of the given client device the one or more global weights of the global ML model.

In some implementations, the global ML model may be an audio-based global ML model that is utilized in processing audio data.

In some implementations, the global ML model may be a vision-based global ML model that is utilized in processing vision data.

In some implementations, a method performed by one or more processors of a client device is provided and includes identifying, at a remote server, a global machine learning (ML) model, the global ML model being initially trained at the remote server, and the global ML model including one or more global weights; determining, at the remote server, and based on at least the one or more global weights, server-based data to be utilized in modifying client gradients; and transmitting, from the remote server and to a plurality of client devices, (i) the global ML model, and (ii) the server-based data. Transmitting (i) the global ML model, and (ii) the server-based data to a given client device, of the plurality of client devices, causes the given client device to: generate, based on processing given client data locally at the given client device and based on the server-based data and using the global ML model, a given client gradient for utilization in updating the one or more global weights; and transmit, to the remote server and from the given client device, the given client gradient. The method further includes generating, based on at least the given client gradient, an updated global ML model, the updated global ML model including one or more updated global weights.

Various implementations can include a non-transitory computer readable storage medium storing instructions executable by one or more processors (e.g., central processing unit(s) (CPU(s)), graphics processing unit(s) (GPU(s)), digital signal processor(s) (DSP(s)), and/or tensor processing unit(s) (TPU(s)) to perform a method such as one or more of the methods described herein. Other implementations can include an automated assistant client device (e.g., a client device including at least an automated assistant interface for interfacing with cloud-based automated assistant component(s)) that includes processor(s) operable to execute stored instructions to perform a method, such as one or more of the methods described herein. Yet other implementations can include a system of one or more servers that include one or more processors operable to execute stored instructions to perform a method such as one or more of the methods described herein.

What is claimed is:

1. A method implemented by one or more processors, the method comprising:
identifying, at a remote server, a global machine learning (ML) model, the global ML model being initially trained at the remote server, and the global ML model including one or more global weights;
determining, at the remote server, and based on at least the one or more global weights, a client augmenting gradient for a server data set utilized in training the global ML model;
determining, at the remote server, and based on at least the one or more global weights, a server augmenting gradient for a client data set utilized in training the global ML model;
transmitting, from the remote server and to a plurality of client devices, (i) the global ML model, and (ii) the client augmenting gradient, wherein transmitting (i) the global ML model, and (ii) the client augmenting gradient to a given client device, of the plurality of client devices, causes the given client device to:
generate, based on processing given client data locally at the given client device and using the global ML model, a given client gradient for utilization in updating the one or more global weights;
generate, based on the given client gradient and based on the client augmenting gradient, a given augmented client gradient; and
transmit, to the remote server and from the given client device, the given augmented client gradient;
generating, based on a given server gradient and the server augmenting gradient, a given augmented server gradient; and
generating, based on the given augmented client gradient and the given augmented server gradient, an updated global ML model, the updated global ML model including one or more updated global weights.

2. The method of claim 1,
wherein transmitting (i) the global ML model, and (ii) the client augmenting gradient to a given additional client device, of the plurality of client devices and in addition to the given client device, causes the given additional client device to:
generate, based on processing given additional client data locally at the given additional client device and using the global ML model, a given additional client gradient for utilization in updating the one or more global weights;
generate, based on the given additional client gradient and based on the client augmenting gradient, a given additional augmented client gradient; and
transmit, to the remote server and from the given additional client device, the given additional augmented client gradient.

3. The method of claim 2, wherein generating the updated global ML model is further based on the given additional augmented client gradient and the given additional augmented server gradient.

4. The method of claim 1,
wherein transmitting (i) the global ML model, and (ii) the client augmenting gradient to the given client device further causes the given client device to:
generate, based on processing corresponding additional given additional client data locally at the given client device and using the global ML model, a plurality of corresponding given additional client gradients for utilization in updating the one or more global weights;
generate, based on the given plurality of corresponding given additional client gradients and based on the client augmenting gradient, a plurality of corresponding given additional augmented client gradients; and
aggregate the given augmented client gradient and the plurality of corresponding given additional augmented client gradients to generate a given aggregated augmented client gradient, wherein the given augmented client gradient transmitted to the remote system is the given aggregated augmented client gradient.

5. The method of claim 1, further comprising:
generating the given server gradient based on processing additional server data, that is in addition to server data included in the server data set utilized to initially train the global ML model, using the global ML model.

6. The method of claim 1, further comprising:
determining, at the remote server, and based on at least the one or more updated global weights, an updated server augmenting gradient for the client data set utilized in training the global ML model;
determining, at the remote server, and based on at least the one or more updated global weights, an updated client augmenting gradient for the server data set utilized in training the global ML model;
transmitting, from the remote server and to a plurality of client devices, (iii) the updated global ML model, and (iv) the updated client augmenting gradient, wherein transmitting (iii) the updated global ML model, and (iv) the updated client augmenting gradient to the given client device causes the given client device to:
generate, based on processing additional given client data locally at the given client device and using the updated global ML model, a given additional client gradient for utilization in further updating the one or more updated global weights;
generate, based on the given additional client gradient and based on the updated client augmenting gradient, a given additional augmented client gradient; and
transmit, to the remote server and from the given client device, the given additional augmented client gradient;
generating, based on an additional server gradient and the updated server augmenting gradient, a given additional augmented server gradient; and
generating, based on the given additional augmented client gradient and the given additional augmented server gradient, a further updated global ML model, the further updated global ML model including one or more further updated global weights.

7. The method of claim 1, wherein the given augmented client gradient is a weighted or non-weighted sum of the given client gradient and the client augmenting gradient.

8. The method of claim 7, wherein the given augmented server gradient is a weighted or non-weighted sum of the given server gradient and the server augmenting gradient.

9. The method of claim 1, further comprising:
determining, at the remote server, whether one or more conditions are satisfied; and
in response to determining that the one or more conditions are satisfied:
transmitting, from the remote server and to the plurality of client devices, (iii) the updated global ML model, wherein transmitting (iii) the updated global ML model to the given client device causes the given client device to:
store, in on-device storage of the given client device, the updated global ML model; and
cause the updated global ML model to be utilized in processing subsequent client data locally at the given client device.

10. The method of claim 9, wherein the one or more conditions comprise one or more of: a threshold quantity of gradients being utilized in generating the updated ML model, a threshold duration of time elapsing, or a threshold performance measure being satisfied by the updated global ML model.

11. The method of claim 1, wherein transmitting the global ML model to the given client device causes the given client device to:
store, in on-device storage of the given client device the one or more global weights of the global ML model.

12. The method of claim 1, wherein the global ML model is an audio-based global ML model that is utilized in processing audio data.

13. The method of claim 1, wherein the global ML model is a vision-based global ML model that is utilized in processing vision data.

14. A method implemented by one or more processors, the method comprising:
identifying, at a remote server, a global machine learning (ML) model, the global ML model being initially trained at the remote server, and the global ML model including one or more global weights;
determining, at the remote server, and based on at least the one or more global weights, a client augmenting gradient for a server data set utilized in training the global ML model;
transmitting, from the remote server and to a plurality of client devices, (i) the global ML model, and (ii) the client augmenting gradient, wherein transmitting (i) the global ML model, and (ii) the client augmenting gradient to a given client device, of the plurality of client devices, causes the given client device to:
generate, based on processing given client data locally at the given client device and using the global ML model, a given client gradient for utilization in updating the one or more global weights;
generate, based on the given client gradient and based on the client augmenting gradient, a given augmented client gradient; and
transmit, to the remote server and from the given client device, the given augmented client gradient; and
generating, based on at least the given augmented client gradient, an updated global ML model, the updated global ML model including one or more updated global weights.

15. The method of claim 14,
wherein transmitting (i) the global ML model, and (ii) the client augmenting gradient to a given additional client device, of the plurality of client devices and in addition to the given client device, causes the given additional client device to:
generate, based on processing given additional client data locally at the given additional client device, a given additional client gradient for utilization in updating the one or more global weights;
generate, based on the given additional client gradient and based on the client augmenting gradient, a given additional augmented client gradient; and
transmit, to the remote server and from the given additional client device, the given additional augmented client gradient.

16. The method of claim 15, wherein generating the updated global ML model is further based on the given additional augmented client gradient and the given additional augmented client gradient.

17. The method of claim 14,
wherein transmitting (i) the global ML model, and (ii) the client augmenting gradient to the given client device further causes the given client device to:
generate, based on processing corresponding additional given additional client data locally at the given client device and using the global ML model, a plurality of corresponding given additional client gradients for utilization in updating the one or more global weights;
generate, based on the given plurality of corresponding given additional client gradients and based on the client augmenting gradient, a plurality of corresponding given additional augmented client gradients; and
aggregate the given augmented client gradient and the plurality of corresponding given additional augmented client gradients to generate a given aggregated augmented client gradient, wherein the given augmented client gradient transmitted to the remote system is the given aggregated augmented client gradient.

18. The method of claim 14, further comprising:
determining, at the remote server, and based on at least the one or more updated global weights, an updated client augmenting gradient for the server data set utilized in training the global ML model;
transmitting, from the remote server and to a plurality of client devices, (iii) the updated global ML model, and (iv) the updated client augmenting gradient, wherein transmitting (iii) the updated global ML model, and (iv) the updated client augmenting gradient to the given client device causes the given client device to:
generate, based on processing additional given client data locally at the given client device and using the updated global ML model, a given additional client gradient for utilization in further updating the one or more updated global weights;
generate, based on the given additional client gradient and based on the updated client augmenting gradient, a given additional augmented client gradient; and
transmit, to the remote server and from the given client device, the given additional augmented client gradient; and
generating, based on at least the given additional augmented client gradient, a further updated global ML model, the further updated global ML model including one or more further updated global weights.

19. The method of claim 14, wherein the given augmented client gradient is a weighted or non-weighted sum of the given client gradient and the client augmenting gradient.

20. A method implemented by one or more processors, the method comprising:
identifying, at a remote server, a global machine learning (ML) model, the global ML model being initially trained at the remote server, and the global ML model including one or more global weights;
determining, at the remote server, and based on at least the one or more global weights, server-based data to be utilized in modifying client gradients;
transmitting, from the remote server and to a plurality of client devices, (i) the global ML model, and (ii) the server-based data, wherein transmitting (i) the global ML model, and (ii) the server-based data to a given client device, of the plurality of client devices, causes the given client device to:
generate, based on processing given client data locally at the given client device and based on the server-based data and using the global ML model, a given client gradient for utilization in updating the one or more global weights; and
transmit, to the remote server and from the given client device, the given client gradient; and
generating, based on at least the given client gradient, an updated global ML model, the updated global ML model including one or more updated global weights.
